(19) United States
(12) Patent Application Publication
(10) Pub. No.: US 2009/0092857 A1
(43) Pub. Date: Apr. 9, 2009

(54) METHOD OF MANUFACTURING MAGNETIC RECORDING MEDIUM AND MAGNETIC RECORDING MEDIUM MANUFACTURED BY THE SAME

(75) Inventors: Ayako MATSUMOTO, Kanagawa (JP); Satoshi Matsubaguchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/244,556

(22) Filed: Oct. 2, 2008

(30) Foreign Application Priority Data
Oct. 3, 2007 (JP) 2007-260409

(51) Int. Cl. G11B 5/842; G11B 5/68

(52) U.S. Cl. 428/842.3; 427/128

(57) ABSTRACT

The present invention relates to a method of manufacturing a magnetic recording medium comprising coating a magnetic layer coating liquid comprising a ferromagnetic hexagonal ferrite powder and a binder to form a coating film, subjecting the coating film to orientation processing while the coating film is still wet, and drying the coating film to form a magnetic layer. The magnetic layer coating liquid is prepared by subjecting a ferromagnetic hexagonal ferrite powder with an average plate diameter of 10 to 50 nm to a dry comminution step, subjecting the ferromagnetic hexagonal ferrite powder to a first dispersion step together with a binder to prepare a dispersion liquid, and sequentially subjecting the dispersion liquid obtained to a second dispersion step and a filtering step. The dispersion liquid obtained by the first dispersion step comprises a dry solid component in an amount, as measured after filtration, of 15 percent or less.

### CROSS-REFERENCE TO RELATED APPLICATIONS

This application claims the benefit of priority under 35 USC 119 to Japanese Patent Application No. 2007-260409 filed on Oct. 3, 2007, which is expressly incorporated herein by reference in its entirety.

### FIELD OF THE INVENTION

The present invention relates to a method of manufacturing a high-capacity magnetic recording medium, and more particularly, to a method of manufacturing a magnetic recording medium having good electromagnetic characteristics in the high-density recording region. The present invention further relates to the magnetic recording medium obtained by the above method.

### DISCUSSION OF THE BACKGROUND

In recent years, means for rapidly transmitting information have undergone marked development, making it possible to transmit data and images comprising huge amounts of information. As these data transmission techniques have advanced, there has been demand for higher recording capacity in recording media for the recording, reproduction, and storage of information.

Techniques of increasing the recording density, such as reducing the size of the magnetic powder particles, increasing the packing density of these particles in coatings, achieving smooth coatings, and reducing the thickness of the magnetic layer, have been proposed as means of achieving higher density recording in an approach from the magnetic recording medium manufacturing side. Such techniques are disclosed in, for example, Japanese Unexamined Patent Publication (KOKAI) No. 2006-41493 or English language family member US 2005/0282042, Japanese Unexamined Patent Publication (KOKAI) No. 2006-155832, and Japanese Unexamined Patent Publication (KOKAI) No. 2001-256633. The contents of these applications are expressly incorporated herein by reference in their entirety.

As described in the above applications, increasing dispersibility in the magnetic layer is important in achieving high recording capacity. Ferromagnetic metal powders and ferromagnetic hexagonal ferrite powders are widely employed as ferromagnetic powders in the magnetic layer. The tendency of a ferromagnetic powder to aggregate depends on the characteristics of the ferromagnetic powder, particularly the saturation magnetization as and shape of the ferromagnetic powder. The lower the as, the lower the magnetostatic interaction, the lower the tendency to aggregate, and the more readily aggregates are destroyed. Thus, employing ferromagnetic hexagonal ferrite powders that more readily yield a low as than ferromagnetic metal powders is thought to be desirable to avoid lowering of the dispersibility of the magnetic layer due to aggregation of the ferromagnetic powder. However, investigation by the present inventors has revealed that the ferromagnetic hexagonal ferrite powders (also referred to simply as “hexagonal ferrite” hereinafter) present the following obstacles to achieving a higher degree of dispersion.

In the process of manufacturing a magnetic recording medium, the practice of coating a magnetic layer coating liquid on a nonmagnetic support and subjecting it to a magnetic field application (orientation processing) while the magnetic layer coating liquid is still wet is widely employed to control the squareness of the magnetic layer. However, when hexagonal ferrite with minute particle size is employed to achieve high density, orientation processing causes aggregation of the hexagonal ferrite (orientation aggregation). Orientation aggregation is thought to be caused by the tendency of hexagonal ferrite to undergo stacking due to its shape. In the relatively low recording density region, this orientation aggregation has little effect on the S/N ratio. However, the thinner the magnetic layer is made and the smaller the hexagonal ferrite particles that are employed to achieve greater density, the more the noise caused by orientation aggregation increases and the greater the effect on the S/N ratio, making it difficult to achieve good electromagnetic characteristics.

### SUMMARY OF THE INVENTION

An aspect of the present invention provides for a means of manufacturing a magnetic recording medium comprising ferromagnetic powder in the form of ferromagnetic hexagonal ferrite powder that is capable of affording good electromagnetic characteristics in the high-density recording region.

The present inventors conducted extensive research into achieving such means, resulting in the following discoveries.

The magnetic layer coating liquid is prepared by mixing and dispersing ferromagnetic powders with other components such as binder in a solvent. The dispersion step is generally divided into two stages: a rough dispersion step conducted in a kneader, and a fine dispersion step employing a bead-like dispersion medium. The present inventors conducted research into the causes of orientation aggregation, resulting in the discovery that it was caused by precipitates in the dispersion liquid obtained following the rough dispersion step not being adequately destroyed during the fine dispersion step, and thus remaining in the magnetic layer coating liquid. That is, in the wet coating film coated in the nonmagnetic support, hexagonal ferrite changed orientation when subjected to a magnetic field application, yielding a desired orientation state. However, when clusters functioning as aggregation nuclei were present, hexagonal ferrite, that was readily displaced by the magnetic field, progressively aggregated together, forming large single clusters of aggregate.

Accordingly, the present inventors conducted further research, resulting in the discovery that the generation of precipitates in the rough dispersion step could be inhibited by subjecting the hexagonal ferrite to a dry comminution step prior to the rough dispersion step. This was attributed firstly to the fact that dry comminution processing destroyed aggregation of the hexagonal ferrite in a dry state, yielding microparticles, and secondly, to the fact that an active surface appeared on the surface of the hexagonal ferrite as a result of the comminution processing, increasing the level of adsorption of binder in the rough dispersion step.

The present invention was devised on the basis of these discoveries.

An aspect of the present invention relates to a method of manufacturing a magnetic recording medium comprising:

coating a magnetic layer coating liquid comprising a ferromagnetic hexagonal ferrite powder and a binder directly or indirectly on a nonmagnetic support to form a coating film,

subjecting the coating film to orientation processing while the coating film is still wet, and

drying the coating film to form a magnetic layer, wherein

the magnetic layer coating liquid is prepared by:

subjecting a ferromagnetic hexagonal ferrite powder with an average plate diameter ranging from 10 to 50 nm to a dry comminution step,

subjecting the ferromagnetic hexagonal ferrite powder obtained by the dry comminution step to a first dispersion step together with a binder to prepare a dispersion liquid, and

sequentially subjecting the dispersion liquid obtained by the first dispersion step to a second dispersion step and a filtering step, the dispersion liquid obtained by the first dispersion step comprising a dry solid component in an amount, as measured after filtration, of equal to or less than 15 percent.

The surface of a coating film formed by coating the magnetic layer coating liquid on a surface with a center surface average roughness Ra of 3.6 nm may have a center surface average roughness Ra of equal to or less than 2.5 nm.

The particle size, D50, of 50 percent of the cumulative volume in the magnetic layer coating liquid may be equal to or less than 40 nm.

The dry comminution step may be carried out with a spiral flow jet mill.

The ferromagnetic hexagonal ferrite powder obtained by the dry comminution step may have a passage rate through a 150 micrometer mesh of equal to or higher than 90% and a stearic acid adsorption capacity of equal to or greater than 7.0 μmol/m².

The ferromagnetic hexagonal ferrite powder obtained by the dry comminution step may have a specific surface area by BET method, S_{BET}, of equal to or greater than 80 m²/g.

The amount of binder adsorbed to the ferromagnetic hexagonal ferrite powder in the dispersion liquid obtained by the first dispersion step may range from 9.8 to 12.0 weight parts per 100 weight parts of the ferromagnetic hexagonal ferrite powder.

The magnetic layer formed may have a squareness ranging from 0.5 to 0.9 in a longitudinal direction.

The magnetic layer formed may have a thickness ranging from 10 to 100 nm.

The ratio, Sdc/Sac, of an average area Sdc of magnetic clusters in a DC demagnetized state to an average area Sac of magnetic clusters in an AC demagnetized state as measured by a magnetic force microscope, MFM, may range from 0.8 to 2.0 in the magnetic recording medium obtained.

The first dispersion step may be carried out with an open kneader, ultrasonic disperser, or a disper.

The second dispersion step may be carried out by stirring the dispersion liquid obtained by the first dispersion step with a dispersion medium in the form of beads.

The above method may comprise coating a nonmagnetic layer coating liquid comprising a nonmagnetic powder and a binder on the nonmagnetic support and drying the nonmagnetic layer coating liquid to form a nonmagnetic layer, and coating the magnetic layer coating liquid on the nonmagnetic layer.

A further aspect of the present invention relates to a magnetic recording medium, manufactured by the above method.

The present invention can provide a magnetic recording medium of desired orientation state and good dispersibility that is capable of achieving excellent electromagnetic characteristics in the high-density region.

Other exemplary embodiments and advantages of the present invention may be ascertained by reviewing the present disclosure.

### DETAILED DESCRIPTIONS OF THE EMBODIMENTS

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Method of Manufacturing Magnetic Recording Medium

The present invention relates to a method of manufacturing a magnetic recording medium comprising coating a magnetic layer coating liquid comprising a ferromagnetic hexagonal ferrite powder and a binder directly or indirectly on a nonmagnetic support to form a coating film, subjecting the coating film to orientation processing while the coating film is still wet, and drying the coating film to form a magnetic layer. In the method of manufacturing a magnetic recording medium of the present invention, the magnetic layer coating liquid is prepared by subjecting a ferromagnetic hexagonal ferrite powder with an average plate diameter ranging from 10 to 50 nm to a dry comminution step, subjecting the ferromagnetic hexagonal ferrite powder obtained by the dry comminution step to a first dispersion step together with a binder to prepare a dispersion liquid, and sequentially subjecting the dispersion liquid obtained by the first dispersion step to a second dispersion step and a filtering step. In the above method, the dispersion liquid obtained by the first dispersion step comprises a dry solid component in an amount, as measured after filtration, of equal to or less than 15 percent. Subjecting the ferromagnetic hexagonal ferrite powder to dry comminution processing prior to the first dispersion step in this manner makes it possible to inhibit orientation aggregation and obtain a magnetic layer with little aggregate by diminishing the precipitate in the dispersion liquid obtained by the first dispersion step.

The above “dry comminution step,” “first dispersion step,” “second dispersion step,” and “filtering step” will be described in detail below.

### Dry Comminution Step

Minimal particles of a granular substance that cannot be further divided are called “primary particles,” and particles produced by the aggregation of primary particles are called “secondary particles.” “Comminution” refers to the destruction of aggregation between particles so that secondary particles approach primary particles. The “dry comminution step” refers to comminution processing conducted on a dry granular substance. In the present invention, hexagonal ferrites are subjected to a dry comminution step prior to being mixed with magnetic layer coating liquid components such as binder. The dry comminution processing can destroy aggregation of the hexagonal ferrite to produce microparticles and expose the surfaces of primary particles that were positioned within the aggregate (secondary particles) by destroying aggregation. The exposed primary particle surfaces are thought to be highly active and adsorb well to binder. Thus, it is thought that precipitates in the dispersion liquid following the first dispersion step can be reduced.

The average plate diameter of the hexagonal ferrite ranges from 10 to 50 nm. When the average plate diameter is less than 10 nm, reproduction output deteriorates due to thermal fluctuation, and there is a lack of suitability to long-term recording storage. When the average plate diameter exceeds 50 nm, the number of particles per bit volume decreases, making it difficult to ensure an adequate S/N ratio. The average plate diameter of the hexagonal ferrite is desirably 15 to 40 nm, preferably 18 to 30 nm.

The average diameter of the hexagonal ferrite is a value that can be calculated by the following method, for example.

Hexagonal ferrite particles are diluted with water, placed on a Cu 200 mesh to which a carbon film has been adhered, and dried. A transmission electron microscope (TEM), such as a TEM Model H-9000 made by Hitachi, is employed to capture images at a magnification of 100,000-fold, and the images are printed on photographic paper at a total magnification of 500,000-fold to obtain particle photographs. The contours of the particles are traced from the photographs with a digitizer and the size of the particles is measured with image analysis software KS400, made by Carl Zeiss. The size of 500 particles is measured and the measured values are averaged to obtain the average plate diameter.

The dry comminution step is generally conducted with a comminution device known as a jet mill (or jet comminuter). The term “jet mill” refers to a comminution device that comminutes particles by using high-pressure air or vapor to cause particles to collide with each other. In the present invention, a jet mill of the type that employs high pressure air to cause particles to collide with each other is used for dry processing. The use of a jet mill is desirable because it comminutes by causing starting materials to collide with each other, reducing the contamination due to abrasion encountered in comminuters and comminution mills. It is also capable of comminuting a starting material down to close to primary particles. Examples of such jet mills are spiral flow jet mills, impact-type jet mills, fluidized bed jet mills. Of these, spiral flow jet mills are desirable. The term “spiral flow jet mill” refers to a jet mill utilizing a spiral flow of gas, in which the particles to be comminuted are picked up by a gas flow and delivered into the interior of the mill and processing is conducted by forming a closed circuit with a grader. The use of a spiral jet mill permits the simultaneous achievement of both comminution and uniform particle size distribution.

Examples of spiral flow jet mills are the model Nanojet Miser NJ 100 made by Aishin Nanotechnologies; the STJ series made by Seishin Enterprise Co., Ltd.; and the NJ series made by Aishin Nanotechnologies. Processing conditions within spiral flow jet mills include the starting material (hexagonal ferrite) introduction rate and introduction pressure, powder comminuting pressure of the gas flow, and frequency of introduction into the jet mill (how many times a given sample is processed in the jet mill). By adjusting such processing conditions, it is possible to achieve a desired comminution state. The processing conditions can be set based on the jet mill employed. For example, the introduction rate is desirably 5 to 15 kg/hour, the introduction pressure is desirably 0.5 to 2.0 MPa, the powder comminuting pressure is desirably 0.5 to 2.0 MPa, and the introduction frequency is desirably about 1 to 8 times.

The comminution step can reduce the size of the particles of hexagonal ferrite, activate the surface thereof, and increase the surface area thereof. To reduce the precipitate in the dispersion liquid obtained by the first step, the passage rate through a 150 micrometer mesh of the hexagonal ferrite following the comminution step is desirably equal to or higher than 90 percent, with 95 to 100 percent being preferred. The stearic acid adsorption capacity can be employed as an indicator of surface activation of the hexagonal ferrite following the comminution step. The stearic acid adsorption capacity of the hexagonal ferrite following the comminution step is desirably equal to or higher than 7.0 μmol/m², preferably 8 to 10 μmol/m². The surface area, given as the specific surface area S_{BET} as measured by the BET method, is desirably equal to or higher than 80 m²/g, preferably 90 to 120 m²/g. The terms “passage rate through a 150 micrometer mesh” and “stearic acid adsorption capacity” are values, measured by methods described in Examples further below, desirably relating to the hexagonal ferrite when subjected to the first dispersion step following the comminution step. At the end of the comminution step, no major change in measured values is observed within 10 days, for example.

To enhance dispersibility, the hexagonal ferrite following the comminution step is desirably subjected to the dispersion step while maintaining the surface in an active state and maintaining the particles as microparticles. Accordingly, the hexagonal ferrite following the comminution step is desirably subjected to the first dispersion step within at most one month of the dry comminution step, and preferably subjected to the first dispersion step immediately following the dry comminution step.

### First Dispersion Step

The first dispersion step is a step in which the hexagonal ferrite following the comminution step is mixed and dispersed together with binder. The hexagonal ferrite and binder can be mixed with other components of the magnetic layer coating liquid in the first dispersed step, these components can be mixed in the second dispersion step, or various starting materials can be divided and separately added in the first dispersion step and second dispersion step.

The first dispersion step can be conducted with a device capable of mixing and dispersion components such as hexagonal ferrite and other components such as binder, such as a kneader, stirrer, or disperser. A kneader with a strong kneading force, such as an open kneader, continuous kneader, pressure kneader, or extruder, is desirably employed as kneader. The details of such kneaders are described in Japanese Unexamined Patent Publication (KOKAI) Heisei Nos. 1-106338 and 1-79274. The contents of these applications are expressly incorporated herein by reference in their entirety. Kneading processing desirably consists of equal to or more than 240 minutes of kneading.

Since a comminution step is conducted before the first dispersion step in the present invention, a high degree of dispersion can be achieved without the use of a kneader. It is also possible to conduct the first dispersion step with an ultrasonic disperser or disper. When employing an ultrasonic disperser, the ultrasonic dispersion is desirably conducted under dispersion conditions of, for example, equal to or more than 30 minutes at a frequency of 20 KHz. When employing a disper, stirring is desirably conducted under conditions of equal to or more than 30 minutes at a rotational speed of equal to or more than 150 rpm.

The fewer precipitates in the dispersion liquid obtained by the first dispersion step, the easier it is to inhibit orientation aggregation. The quantity of precipitates in the dispersion liquid can be evaluated based on the amount of dry solid components as measured after filtration. In the present invention, the term “the amount of a dry solid component as measured after filtration” refers to a value that is measured by the following method.

The dispersion liquid is diluted with a double quantity of solvent (such as methyl ethyl ketone), the mixture is passed through a filter having an average pore diameter of 1.0 micrometer, and the solid components remaining on the filter are recovered, dried, and weighed. The value calculated as (amount of dry solid component recovered/amount of solid component in dispersion liquid)×100 gives the amount of a dry solid component as measured after filtration.

In the present invention, the amount of a dry solid component as measured after filtration of the dispersion liquid obtained by the first dispersion step is equal to or less than 15 percent. When the amount of a dry solid component as measured after filtration exceeds 15 percent, aggregation tends to occur in the orientation step and a magnetic recording medium with good electromagnetic characteristics becomes difficult to obtain. The the amount of a dry solid component as measured after filtration is desirably equal to or less than 10 percent, preferably equal to or less than 5 percent. The lower limit is ideally 0 percent. In the present invention, subjecting the hexagonal ferrite to dry comminution processing prior to the first dispersion step as set forth above can yield a dispersion liquid with a reduced quantity of precipitates in the first dispersion step. The first dispersion step is desirably conducted immediately after the dry comminution step so that the hexagonal ferrite is subjected to the first dispersion step while the hexagonal ferrite is still in the state of reduced particle size and exposed surface activity achieved by the dry comminution step. When hexagonal ferrite that has been subjected to the dry comminution step is subjected to the first dispersion step following storage for an extended period, it is sometimes difficult to reduce the amount of a dry solid component as measured after filtration to equal to or less than 15 percent. The amount of a dry solid component as measured after filtration is a value that is measured within 5 days of the end of the first dispersion step.

The hexagonal ferrite that has been subjected to comminution processing as set forth above can have heightened surface activity and an increased level of binder adsorption. This can also contribute to enhancing dispersibility. The amount of binder adsorbed to the hexagonal ferrite in the dispersion liquid obtained by the first dispersion step is desirably 9.8 to 12.0 weight parts, preferably 10.0 to 11.5 weight parts, per 100 weight parts of hexagonal ferrite. The above amount of binder adsorbed to the hexagonal ferrite is a value in the dispersion liquid obtained by the first dispersion step. It is desirably a value in the dispersion liquid when subjected to the second dispersion step. No major change in the value measured is observed within 5 days, for example, of completion of the first dispersion step.

The dispersion liquid obtained by the first dispersion step is then sequentially subjected to the second dispersion step and filtering step. From the perspective of maintaining the dispersion state achieved by the first dispersion step, the second dispersion step is desirably conducted immediately after the first dispersion step.

### Second Dispersion Step and Filtering Step

The second dispersion step is a step in which the dispersion liquid obtained by the first dispersion step is further dispersed. Generally, in the second dispersion step, more minute dispersion is conducted than in the first dispersion step. In the second dispersion step, it is desirable for a dispersion medium in the form of beads to be added to the dispersion liquid obtained by the first step and for the mixture to be stirred. Suitable examples of beadlike media are high specific gravity dispersion media in the form of zirconia beads, titania beads, and steel beads. The particle diameter and fill rate of these dispersion media can be optimized for use. Known dispersion devices can be employed. The dispersion conditions employed are desirably a rotational speed of 1,500 to 3,000 rpm, 250 to 500 weight parts of beads 0.01 to 0.5 mm in diameter per 100 weight parts of coating liquid, and a dispersion time of 720 to 2,160 minutes.

The dispersion liquid obtained by the second dispersion step is subjected to a filtering step. The filtering step can be conducted by passing the dispersion liquid through a filter having an average pore diameter of about 0.1 to 4 micrometers, for example.

The present invention can yield a magnetic layer coating liquid with good dispersibility by means of a dry comminution step, first and second dispersion steps, and a filtering step. The surface properties of the coating film obtained by coating the magnetic layer coating liquid can be employed as an indicator of the dispersibility of the magnetic layer coating liquid. Specifically, the center surface average roughness Ra of the coating film surface formed by coating and drying the magnetic layer coating liquid on a base surface with a center surface average roughness Ra of 3.6 nm is desirably equal to or less than 2.5 nm, preferably 1.5 to 2.3 nm.

The particle size distribution of the magnetic layer coating liquid obtained following the filtering step is desirably rendered uniform to inhibit aggregation. In particular, a spiral flow jet mill can be employed in the dry comminution step to achieve a uniform particle size distribution. The particle size distribution of the hexagonal ferrite in the magnetic layer coating liquid can be evaluated based on the particle diameter of 50 percent of the cumulative volume (referred to as the “D50” hereinafter) of the hexagonal ferrite in the magnetic layer coating liquid. The D50 of the magnetic layer coating liquid is desirably equal to or less than 40 nm, preferably 20 to 35 nm.

The dispersibility of the magnetic layer coating liquid relates to the magnetic layer coating liquid following the filtering step, and desirably relates to the coating liquid when coated on the nonmagnetic support. No major change in Ra or D50 above is observed for values measured within 10 days, for example, following the conclusion of the filtering step.

The method of manufacturing a magnetic recording medium of the present invention will be described in greater detail below.

### Nonmagnetic Support

The magnetic layer coating liquid thus prepared is coated directly or indirectly on a nonmagnetic support. It can be coated directly on the nonmagnetic support, or on the nonmagnetic layer, described further below.

A known film in the form of a polyester such as polyethylene terephthalate or polyethylene naphthalate, polyolefins, cellulose triacetate, polycarbonate, polyamide, polyimide, polyamidoimide, polysulfone, polyaramide, aromatic polyamide, or polybenzooxazol can be employed as the nonmagnetic support. The use of a high-strength support such as polyethylene naphthalate or polyamide is desirable. As needed, laminated supports such as those disclosed in Japanese Unexamined Patent Publication (KOKAI) Heisei No. 3-224127, which is expressly incorporated herein by reference in its entirety, can be employed to vary the surface roughness of the magnetic surface and nonmagnetic support surface. These supports may be subjected beforehand to corona discharge treatment, plasma treatment, adhesion enhancing treatment, heat treatment, dust removal, and the like. An aluminum or glass support can also be employed as the support.

Of these, a polyester support (referred to simply as “polyester” hereinafter) is desirable. The polyester is desirably comprised of dicarboxylic acid and a diol, such as polyethylene terephthalate and polyethylene naphthalate.

Examples of the dicarboxylic acid component serving as the main structural component are: terephthalic acid, isophthalic acid, phthalic acid, 2,6-naphthalene dicarboxylic acid, 2,7-naphthalene dicarboxylic acid, diphenylsulfone dicarboxylic acid, diphenylether dicarboxylic acid, diphenylethane dicarboxylic acid, cyclohexane dicarboxylic acid, diphenyl dicarboxylic acid, diphenylthioether dicarboxylic acid, diphenylketone dicarboxylic acid, and phenylindane dicarboxylic acid.

Examples of the diol component are: ethylene glycol, propylene glycol, tetramethylene glycol, cyclohexane dimethanol, 2,2-bis(4-hydroxyphenyl)propane, 2,2-bis(4-hydroxyethoxyphenyl)propane, bis(4-hydroxyphenyl)sulfone, bisphenolfluorene dihydroxyethyl ether, diethylene glycol, neopentyl glycol, hydroquinone, and cyclohexanediol.

Among polyesters employing the above compounds as main structural components, those comprising main structural components in the form of terephthalic acid and/or 2,6-naphthalene dicarboxylic acid as a dicarboxylic acid component, and ethylene glycol and/or 1,4-cyclohexane dimethanol as a diol component, are desirable from the perspectives of transparency, mechanical strength, dimensional stability, and the like.

Among these, polyesters comprising main structural components in the form of polyethylene terephthalate or polethylene-2,6-naphthalate; copolymer polyesters comprised of terephthalic acid, 2,6-naphthalene dicarboxylic acid, and ethylene glycol; and polyesters comprising main structural components in the form of mixtures of two or more of these polyesters are preferred. Polyesters comprising polyethylene-2,6-naphthalate as the main structural component are of even greater preference.

The polyester may be biaxially oriented, and may be a laminate with two or more layers.

Other copolymer components may be copolymerized and other polyesters may be mixed into the polyester. Examples are the dicarboxylic acid components and diol components given above by way of example, and polyesters comprised of them.

To prevent delamination when used in films, aromatic dicarboxylic acids having sulfonate groups or ester-forming derivatives thereof, dicarboxylic acids having polyoxyalkylene groups or ester-forming derivatives thereof, diols having polyoxyalkylene groups, or the like can be copolymerized in the polyester.

Among these, 5-sodiumsulfoisophthalic acid, 2-sodiumsulfoterephthalic acid, 4-sodiumsulfophthalic acid, 4-sodiumsulfo-2,6-naphthylene dicarboxylic acid, compounds in which the sodium in these compounds has been replaced with another metal (such as potassium or lithium), ammonium salt, phosphonium salt, or the like, ester-forming compounds thereof, polyethylene glycol, polytetramethylene glycol, polyethylene glycol-polypropylene glycol copolymers, compounds in which the two terminal hydroxy groups of these compounds have been oxidized or the like to form carboxyl groups, and the like are desirable from the perspectives of the polyester polymerization reaction and film transparency. The ratio of copolymerization for the above purpose is desirably 0.1 to 10 mol percent based on the dicarboxylic acid constituting the polyester.

Further, to increase heat resistance, a bisphenol compound or a compound having a naphthalene ring or cyclohexane ring can be copolymerized. The copolymerization ratio of the above compounds is desirably 1 to 20 mol percent based on the dicarboxylic acid constituting the polyester.

The above polyesters can be manufactured according to conventional known polyester manufacturing methods. An example is the direct esterification method, in which the dicarboxylic acid component is directly esterification reacted with the diol component. It is also possible to employ a transesterification in which a dialkyl ester is first employed as a dicarboxylic acid component to conduct a transesterification reaction with a diol component, and the product is then heated under reduced pressure to remove the excess diol component and conduct polymerization. In this process, transesterification catalysts or polymerization catalysts may be employed and heat-resistant stabilizers added as needed.

One or more of various additives such as anticoloring agents, oxidation inhibitors, crystal nucleus agents, slipping agents, stabilizers, antiblocking agents, UV absorbents, viscosity-regulating agents, defoaming transparency-promoting agents, antistatic agents, pH-regulating agents, dyes, pigments, and reaction-stopping agents can be added at any step during synthesis.

Filler can be added to the polyester. Examples of fillers are: inorganic powders such as spherical silica, colloidal silica, titanium oxide, and alumina, and organic fillers such as crosslinked polystyrene and silicone resin.

Further, to render the supports highly rigid, these materials can be highly oriented, and surface layers of metals, semimetals, and oxides thereof can be provided.

The nonmagnetic support is desirably 3 to 80 micrometers, preferably 3 to 50 micrometers, and more preferably, 3 to 10 micrometers in thickness. The center surface average roughness (Ra) of the support surface is desirably equal to or less than 6 nm, preferably equal to or less than 4 nm. The above Ra is a value that is measured with an HD2000 made by WYKO.

Further, the Young's modulus of the nonmagnetic support is desirably equal to or greater than 6.0 GPa, preferably equal to or greater than 7.0 GPa, in the longitudinal and width directions.

### Ferromagnetic Hexagonal Ferrite Powder

Hexagonal ferrite powder with a volume of 1,000 to 20,000 nm³ is desirable in the magnetic layer, and such powder with a volume of 2,000 to 8,000 nm³ is preferred. Within this range, it is possible to effectively inhibit a decrease in magnetic characteristics due to thermal fluctuation and obtain a good C/N (S/N) ratio while maintaining low noise.

The above volume is a value that is calculated from the plate diameter and axial length (plate thickness) when a hexagonal columnar shape is envisioned for hexagonal ferrite powder.

The average size of the hexagonal ferrite in the magnetic layer can be calculated by the following method. A suitable quantity of the magnetic layer is peeled off. To 30 to 70 mg of the magnetic layer that has been peeled off is added n-butylamine, the mixture is sealed in a glass tube, and the glass tube is placed in a thermal decomposition device. The glass tube is then heated for about a day at 140° C. After cooling, the contents are recovered from the glass tube and centrifugally separated to separate the liquid from the solid component. The solid component that has been separated is cleaned with acetone to obtain a powder sample for a transmission electron microscope (TEM). The particles in this sample are photographed at a magnification of 100,000-fold with a model H-9000 transmission electron microscope made by Hitachi and printed on photographic paper at a total magnification of 500,000-fold to obtain particle photographs. The targeted magnetic material is selected from the particle photographs, the contours of the powder material are traced with a digitizer, and the size of the particles is measured with KS-400 image analyzer software from Carl Zeiss. The size of 500 particles is measured and the measured values are averaged to obtain the average size.

Examples of hexagonal ferrite powders are barium ferrite, strontium ferrite, lead ferrite, calcium ferrite, and various substitution products thereof such as Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite powder in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed.

The particle size of the ferromagnetic ferrite powder is, as an average plate diameter, 10 to 50 nm, more preferably a size with the above-described volume. At an average plate diameter of equal to or greater than 10 nm, the amount of magnetic materials involving in recording due to thermal fluctuation can be readily ensured even when the particle size distribution is considered. At an average plate diameter of equal to or less than 50 nm, high output and low noise can be ensured at high linear recording density. The average plate diameter of the hexagonal ferrite powder preferably ranges from 15 to 40 nm, more preferably 18 to 30 nm.

An average plate ratio [average of (plate diameter/plate thickness)] of the hexagonal ferrite powder preferably ranges from 1.5 to 4.5, more preferably 2.0 to 3.5. When the average plate ratio ranges from 1.5 to 4.5, adequate orientation can be achieved while maintaining high filling property in the magnetic layer, increased noise due to stacking between particles can be suppressed, and the magnetic recording medium with excellent durability can be obtained. The specific surface area by BET method (S_{BET}) within the above particle size range is preferably equal to or higher than 40 m²/g, more preferably 40 to 200 m²/g, and particularly preferably, 60 to 100 m²/g.

Narrow distributions of particle plate diameter and plate thickness of the hexagonal ferrite powder are normally good. About 500 particles can be randomly measured in a transmission electron microscope (TEM) photograph of particles to measure and compare the particle plate diameter and plate thickness. The distributions of particle plate diameter and plate thickness are often not a normal distribution. However, when expressed as the standard deviation to the average size, a/average size is 0.1 to 1.0. The particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known.

A coercivity (Hc) of the hexagonal ferrite powder of 143.3 to 318.5 kA/m (1800 to 4,000 Oe) can normally be achieved. The coercivity (Hc) of the hexagonal ferrite powder preferably ranges from 159.2 to 238.9 kA/m (2,000 to 3,000 Oe), more preferably 191.0 to 214.9 kA/m (2,200 to 2,800 Oe). The coercivity (Hc) can be controlled by particle size (plate diameter and plate thickness), the types and quantities of elements contained, substitution sites of the element, the particle producing reaction conditions, and the like.

The saturation magnetization (σₛ) of the hexagonal ferrite powder preferably ranges from 30 to 80 A·m²/kg (30 to 80 emu/g). The higher saturation magnetization (σₛ) is preferred, however, it tends to decrease with decreasing particle size. Known methods of improving saturation magnetization (σₛ) are combining spinel ferrite with magnetoplumbite ferrite, selection of the type and quantity of elements incorporated, and the like. It is also possible to employ W-type hexagonal ferrite. When dispersing the magnetic material, the particle surface of the magnetic material can be processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added normally range from 0.1 to 10 weight percent relative to the mass of the magnetic material. The pH of the magnetic material is also important to dispersion. A pH of about 4 to 12 is usually optimum for the dispersion medium and polymer. From the perspective of the chemical stability and storage properties of the medium, a pH of about 6 to 11 is preferable. Moisture contained in the magnetic material also affects dispersion. There is an optimum level for the dispersion medium and polymer, usually selected from the range of 0.01 to 2.0 percent.

Methods of manufacturing the hexagonal ferrite powder include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to equal to or greater than 100° C.; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. Any manufacturing method can be selected in the present invention. As needed, the hexagonal ferrite powder can be surface treated with Al, Si, P, or an oxide thereof. The quantity can be set to 0.1 to 10 weight percent of the hexagonal ferrite powder. When applying a surface treatment, the quantity of a lubricant such as a fatty acid that is adsorbed is desirably not greater than 100 mg/m². The hexagonal ferrite powder will sometimes contain inorganic ions such as soluble Na, Ca, Fe, Ni, or Sr. These are desirably substantially not present, but seldom affect characteristics at equal to or less than 200 ppm.

### Binder

Known techniques regarding binders, lubricants, dispersion agents, additives, solvents, dispersion methods and the like for magnetic layer and nonmagnetic layer can be suitably applied to the magnetic layer and nonmagnetic layer of the magnetic recording medium. In particular, known techniques regarding the quantity and types of binders, and quantity added and types of additives and dispersion agents regarding the magnetic layer can be applied.

To achieve highly dispersed and stable state of magnetic particles, binders with good dispersibility are preferably adsorbed to microgranular magnetic powders. Such binder is preferably a binder having good compatibility with solvent, such as a binder comprising polyurethane with radius of inertia of 5 to 25 nm in cyclohexane. Details thereof are described in Japanese Unexamined Patent Publication (KOKAI) Heisei No. 9-27115, which is expressly incorporated herein by reference in its entirety. The above-described binder can achieve good dispersibility and stability in a small quantity, resulting in improvement of dispersion and volume filling rate.

Conventionally known thermoplastic resins, thermosetting resins, reactive resins and mixtures thereof may be employed as binders used. The thermoplastic resins suitable for use have a glass transition temperature of −100 to 150° C., a number average molecular weight of 1,000 to 200,000, preferably from 10,000 to 100,000, and have a degree of polymerization of about 50 to 1,000.

Examples thereof are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, and vinyl ether; polyurethane resins; and various rubber resins. Further, examples of thermosetting resins and reactive resins are phenol resins, epoxy resins, polyurethane cured resins, urea resins, melamine resins, alkyd resins, acrylic reactive resins, formaldehyde resins, silicone resins, epoxy polyamide resins, mixtures of polyester resins and isocyanate prepolymers, mixtures of polyester polyols and polyisocyanates, and mixtures of polyurethane and polyisocyanates. These resins are described in detail in Handbook of Plastics published by Asakura Shoten, which is expressly incorporated herein by reference in its entirety. It is also possible to employ known electron beam-cured resins in each layer. Examples and manufacturing methods of such resins are described in Japanese Unexamined Patent Publication (KOKAI) Showa No. 62-256219, which is expressly incorporated herein by reference in its entirety. The above-listed resins may be used singly or in combination. Preferred resins are combinations of polyurethane resin and at least one member selected from the group consisting of vinyl chloride resin, vinyl chloride—vinyl acetate copolymers, vinyl chloride—vinyl acetate—vinyl alcohol copolymers, and vinyl chloride—vinyl acetate—maleic anhydride copolymers, as well as combinations of the same with polyisocyanate.

Polyurethane resins having a known structure may be employed, such as polyester polyurethane, polyether polyurethane, polyether polyester polyurethane, polycarbonate polyurethane, polyester polycarbonate polyurethane, and polycaprolactone polyurethane.

A binder obtained by incorporating as needed one or more polar groups selected from among —COOM, —SO₃M, —OSO₃M, —P═O(OM)₂, and —O—PαO(OM)₂ (where M denotes a hydrogen atom or an alkali metal base), —OH, —NR₂, —N⁺R₃ (where R denotes a hydrocarbon group), epoxy group, —SH, and —CN into any of the above-listed binders by copolymerization or addition reaction to improve dispersion properties and durability is desirably employed. The quantity of such a polar group ranges from 10⁻¹ to 10⁻⁸ mol/g, preferably from 10⁻² to 10⁻⁶ mol/g.

Specific examples of binders are VAGH, VYHH, VMCH, VAGF, VAGD, VROH, VYES, VYNC, VMCC, XYHL, XYSG, PKHH, PKHJ, PKHC, and PKFE from Union Carbide Corporation; MPR-TA, MPR-TA5, MPR-TAL, MPR-TSN, MPR-TMF, MPR-TS, MPR-TM, and MPR-TAO from Nisshin Kagaku Kogyo K. K.; 1000W, DX80, DX81, DX82, DX83, and 100FD from Denki Kagaku Kogyo K. K.; MR-104, MR-105, MR110, MR100, MR555, and 400X-110A from Nippon Zeon Co., Ltd.; Nippollan N2301, N2302, and N2304 from Nippon Polyurethane Co., Ltd.; Pandex T-5105, T-R3080, T-5201, Burnock D-400, D-210-80, Crisvon 6109, and 7209 from Dainippon Ink and Chemicals Incorporated.; Vylon UR8200, UR8300, UR-8700, RV530, and RV280 from Toyobo Co., Ltd.; Daipheramine 4020, 5020, 5100, 5300, 9020, 9022, and 7020 from Dainichiseika Color & Chemicals Mfg. Co., Ltd.; MX5004 from Mitsubishi Chemical Corporation; Sanprene SP-150 from Sanyo Chemical Industries, Ltd.; and Saran F310 and F210 from Asahi Chemical Industry Co., Ltd.

The quantity of binder added to the magnetic layer and the nonmagnetic layer ranges from, for example, 5 to 50 weight percent, preferably from 10 to 30 weight percent, relative to the weight of the nonmagnetic powder or magnetic powder. When employing vinyl chloride resin, the quantity of binder added is preferably from 5 to 30 weight percent; when employing polyurethane resin, from 2 to 20 weight percent; and when employing polyisocyanate, from 2 to 20 weight percent. They may be employed in combination. However, for example, when head corrosion occurs due to the release of trace amounts of chlorine, polyurethane alone or just polyurethane and isocyanate may be employed. When polyurethane is employed, the glass transition temperature ranges from, for example, −50 to 150° C., preferably from 0 to 100° C.; the elongation at break preferably ranges from 100 to 2,000 percent; the stress at break desirably ranges from 0.05 to 10 kg/mm² (approximately 0.49 to 98 MPa); and the yield point preferably ranges from 0.05 to 10 kg/mm² (approximately 0.49 to 98 MPa).

Examples of polyisocyanates suitable for use in the present invention are tolylene diisocyanate, 4,4′-diphenylmethane diisocyanate, hexamethylene diisocyanate, xylylene diisocyanate, napthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These isocyanates are commercially available under the following trade names, for example: Coronate L, Coronate HL, Coronate 2030, Coronate 2031, Millionate MR and Millionate MTL manufactured by Nippon Polyurethane Industry Co. Ltd.; Takenate D-102, Takenate D-110N, Takenate D-200 and Takenate D-202 manufactured by Takeda Chemical Industries Co., Ltd.; and Desmodule L, Desmodule IL, Desmodule N and Desmodule HL manufactured by Sumitomo Bayer Co., Ltd. They can be used in each layer singly or in combinations of two or more by exploiting differences in curing reactivity.

Additives may be added to the magnetic layer as needed. Examples of such additives are: abrasives, lubricants, dispersing agents, dispersing adjuvants, antifungal agents, antistatic agents, oxidation inhibitors, solvents, and carbon black. Examples of additives are: molybdenum disulfide, tungsten disulfide, graphite, boron nitride, graphite fluoride, silicone oil, polar group-comprising silicone, fatty acid-modified silicone, fluorosilicone, fluoroalcohols, fluoroesters, polyolefin, polyglycol, polyphenyl ether, phenyl phosphonic acid, benzyl phosphonic acid, phenethyl phosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, toluylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, nonylphenylphosphonic acid, other aromatic ring-comprising organic phosphonic acids, alkali metal salts thereof, octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, isoeicosylphosphonic acid, other alkyl phosphonoic acid, alkali metal salts thereof, phenyl phosphoric acid, benzyl phosphoric acid, phenethyl phosphoric acid, α-methylbenzylphosphoric acid, 1-methyl-1-phenethylphosphoric acid, diphenylmethylphosphoric acid, diphenyl phosphoric acid, benzylphenyl phosphoric acid, α-cumyl phosphoric acid, toluyl phosphoric acid, xylyl phosphoric acid, ethylphenyl phosphoric acid, cumenyl phosphoric acid, propylphenyl phosphoric acid, butylphenyl phosphoric acid, heptylphenyl phosphoric acid, octylphenyl phosphoric acid, nonylphenyl phosphoric acid, other aromatic phosphoric esters, alkali metal salts thereof, octyl phosphoric acid, 2-ethylhexylphosphoric acid, isooctyl phosphoric acid, isononyl phosphoric acid, isodecyl phosphoric acid, isoundecyl phosphoric acid, isododecyl phosphoric acid, isohexadecyl phosphoric acid, isooctyldecyl phosphoric acid, isoeicosyl phosphoric acid, other alkyl ester phosphoric acids, alkali metal salts thereof, alkylsulfonic acid ester, alkali metal salts thereof, fluorine-containing alkyl sulfuric acid esters, alkali metal salts thereof, lauric acid, myristic acid, palmitic acid, stearic acid, behenic acid, oleic acid, linolic acid, linoleic acid, elaidic acid, erucic acid, other monobasic fatty acids comprising 10 to 24 carbon atoms (which may contain an unsaturated bond or be branched), metal salts thereof, butyl stearate, octyl stearate, amyl stearate, isooctyl stearate, octyl myristate, butyl laurate, butoxyethyl stearate, anhydrosorbitan monostearate, anhydrosorbitan tristearate, other monofatty esters, difatty esters, or polyfatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 22 carbon atoms (which may contain an unsaturated bond or be branched), alkoxyalcohol having 12 to 22 carbon atoms (which may contain an unsaturated bond or be branched) or a monoalkyl ether of an alkylene oxide polymer, fatty acid amides with 2 to 22 carbon atoms, and aliphatic amines with 8 to 22 carbon atoms. Compounds having aralkyl groups, aryl groups, or alkyl groups substituted with groups other than hydrocarbon groups, such as nitro groups, F, Cl, Br, CF₃, CCl₃, CBr₃, and other halogen-containing hydrocarbons in addition to the above hydrocarbon groups, may also be employed.

It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines. Details of these surfactants are described in A Guide to Surfactants (published by Sangyo Tosho K.K.), which is expressly incorporated herein by reference in its entirety.

These lubricants, antistatic agents and the like need not be 100 percent pure and may contain impurities, such as isomers, unreacted material, by-products, decomposition products, and oxides in addition to the main components. These impurities are preferably comprised equal to or less than 30 weight percent, and more preferably equal to or less than 10 weight percent.

Specific examples of these additives are: NAA-102, hydrogenated castor oil fatty acid, NAA-42, Cation SA, Nymeen L-201, Nonion E-208, Anon BF and Anon LG manufactured by NOF Corporation; FAL-205 and FAL-123 manufactured by Takemoto Oil & Fat Co., Ltd.; NJLUB OL manufactured by New Japan Chemical Co. Ltd.; TA-3 manufactured by Shin-Etsu Chemical Co. Ltd.; Armide P and Duomine TDO manufactured by Lion Corporation; BA-41G manufactured by Nisshin OilliO, Ltd.; and Profan 2012E, Newpole PE61 and Ionet MS-400 manufactured by Sanyo Chemical Industries, Ltd.

Carbon black may be added to the magnetic layer as needed. Examples of types of carbon black that are suitable for use in the magnetic layer are: furnace black for rubber, thermal for rubber, black for coloring, and acetylene black. It is preferable that the specific surface area is 5 to 500 m²/g, the DBP oil absorption capacity is 10 to 400 ml/100 g, the particle diameter is 5 to 300 nm, the pH is 2 to 10, the moisture content is 0.1 to 10 percent, and the tap density is 0.1 to 1 g/ml.

Specific examples of types of carbon black employed are: BLACK PEARLS 2000, 1300, 1000, 900, 905, 800, 700 and VULCAN XC-72 from Cabot Corporation; #80, #60, #55, #50 and #35 manufactured by Asahi Carbon Co., Ltd.; #2400B, #2300, #900, #1000, #30, #40 and #10B from Mitsubishi Chemical Corporation; CONDUCTEX SC, RAVEN 150, 50, 40, 15 and RAVEN MT-P from Columbia Carbon Co., Ltd.; and Ketjen Black EC from Ketjen Black International Co., Ltd. The carbon black employed may be surface-treated with a dispersant or grafted with resin, or have a partially graphite-treated surface. The carbon black may be dispersed in advance into the binder prior to addition to the magnetic layer coating liquid. These carbon blacks may be used singly or in combination. When employing carbon black, the quantity preferably ranges from 0.1 to 30 weight percent with respect to the weight of the ferromagnetic powder. In the magnetic layer, carbon black can work to prevent static, reduce the coefficient of friction, impart light-blocking properties, enhance film strength, and the like; the properties vary with the type of carbon black employed. Accordingly, the type, quantity, and combination of carbon blacks employed in the present invention may be determined separately for the magnetic layer and the nonmagnetic layer based on the objective and the various characteristics stated above, such as particle size, oil absorption capacity, electrical conductivity, and pH, and be optimized for each layer. For example, the Carbon Black Handbook compiled by the Carbon Black Association, which is expressly incorporated herein by reference in its entirety, may be consulted for types of carbon black suitable for use in the present invention.

### Abrasive

Known materials chiefly having a Mohs' hardness of equal to or greater than 6 may be employed either singly or in combination as abrasives. These include: α-alumina with an α-conversion rate of equal to or greater than 90 percent, β-alumina, silicon carbide, chromium oxide, cerium oxide, α-iron oxide, corundum, synthetic diamond, silicon nitride, titanium carbide, titanium oxide, silicon dioxide, and boron nitride. Complexes of these abrasives (obtained by surface treating one abrasive with another) may also be employed. There are cases in which compounds or elements other than the primary compound are contained in these abrasives; the effect does not change so long as the content of the primary compound is equal to or greater than 90 percent. The particle size of the abrasive is preferably 0.01 to 2 micrometers. To enhance electromagnetic characteristics, a narrow particle size distribution is desirable. Abrasives of differing particle size may be incorporated as needed to improve durability; the same effect can be achieved with a single abrasive as with a wide particle size distribution. It is preferable that the tap density is 0.3 to 2 g/cc, the moisture content is 0.1 to 5 percent, the pH is 2 to 11, and the specific surface area is 1 to 30 m²/g. The shape of the abrasive employed may be acicular, spherical, cubic, plate-shaped or the like. However, a shape comprising an angular portion is desirable due to high abrasiveness. Specific examples are AKP-12, AKP-15, AKP-20, AKP-30, AKP-50, HIT-20, HIT-30, HIT-55, HIT-60, HIT-70, HIT-80, and HIT-100 made by Sumitomo Chemical Co., Ltd.; ERC-DBM, HP-DBM, and HPS-DBM made by Reynolds Corp.; WA10000 made by Fujimi Abrasive Corp.; UB20 made by Uemura Kogyo Corp.; G-5, Chromex U2, and Chromex U1 made by Nippon Chemical Industrial Co., Ltd.; TF100 and TF140 made by Toda Kogyo Corp.; Beta Random Ultrafine made by Ibiden Co., Ltd.; and B-3 made by Showa Kogyo Co., Ltd. These abrasives may be added as needed to the nonmagnetic layer. Addition of abrasives to the nonmagnetic layer can be done to control surface shape, control how the abrasive protrudes, and the like. The particle size and quantity of the abrasives added to the magnetic layer and nonmagnetic layer should be set to optimal values.

Known organic solvents can be used in any ratio. Examples are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; N,N-dimethylformamide; and hexane.

These organic solvents need not be 100 weight percent pure and may contain impurities such as isomers, unreacted materials, by-products, decomposition products, oxides and moisture in addition to the main components. The content of these impurities is preferably equal to or less than 30 weight percent, more preferably equal to or less than 10 weight percent. Preferably the same type of organic solvent is employed in the magnetic layer and in the nonmagnetic layer. However, the amount added may be varied. The stability of coating is increased by using a solvent with a high surface tension (such as cyclohexanone or dioxane) in the nonmagnetic layer. Specifically, it is preferable that the arithmetic mean value of the magnetic layer solvent composition be not less than the arithmetic mean value of the nonmagnetic layer solvent composition. To improve dispersion properties, a solvent having a somewhat strong polarity is desirable. It is desirable that solvents having a dielectric constant equal to or higher than 15 are comprised equal to or higher than 50 percent of the solvent composition. Further, the dissolution parameter is desirably 8 to 11.

The types and quantities of dispersing agents, lubricants, and surfactants employed in the magnetic layer may differ from those employed in the nonmagnetic layer, described further below, in the present invention. For example (the present invention not being limited to the embodiments given herein), a dispersing agent usually has the property of adsorbing or bonding by means of a polar group. In the magnetic layer, the dispersing agent adsorbs or bonds by means of the polar group primarily to the surface of the ferromagnetic metal powder, and in the nonmagnetic layer, primarily to the surface of the nonmagnetic powder. It is surmised that once an organic phosphorus compound has adsorbed or bonded, it tends not to dislodge readily from the surface of a metal, metal compound, or the like of the dispersing agent. Accordingly, the surface of a ferromagnetic metal powder or the surface of a nonmagnetic powder becomes covered with the alkyl group, aromatic groups, and the like. This enhances the compatibility of the ferromagnetic metal powder or nonmagnetic powder with the binder resin component, further improving the dispersion stability of the ferromagnetic metal powder or nonmagnetic powder. Further, lubricants are normally present in a free state. Thus, it is conceivable to use fatty acids with different melting points in the nonmagnetic layer and magnetic layer to control seepage onto the surface, employ esters with different boiling points and polarity to control seepage onto the surface, regulate the quantity of the surfactant to enhance coating stability, and employ a large quantity of lubricant in the nonmagnetic layer to enhance the lubricating effect. All or some part of the additives employed in the present invention can be added in any of the steps during the manufacturing of coating liquids for the magnetic layer and nonmagnetic layer. For example, there are cases where they are mixed with the ferromagnetic powder prior to the kneading step; cases where they are added during the step in which the ferromagnetic powder, binder, and solvent are kneaded; cases where they are added during the dispersion step; cases where they are added after dispersion; and cases where they are added directly before coating.

### Nonmagnetic Layer

Details of the nonmagnetic layer will be described below. In the present invention, the magnetic layer coating liquid can be coated directly on the nonmagnetic support or on the nonmagnetic layer. Details of coating method will be described further below. The nonmagnetic layer coating liquid comprises at least a nonmagnetic powder and a binder. Both organic and inorganic substances may be employed as the nonmagnetic powder. Carbon black may also be employed. Examples of inorganic substances are metals, metal oxides, metal carbonates, metal sulfates, metal nitrides, metal carbides, and metal sulfides.

Specifically, titanium oxides such as titanium dioxide, cerium oxide, tin oxide, tungsten oxide, ZnO, ZrO₂, SiO₂, Cr₂O₃, α-alumina with an α-conversion rate of 90 to 100 percent, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide may be employed singly or in combinations of two or more. α-iron oxide and titanium oxide are preferred.

The nonmagnetic powder may be acicular, spherical, polyhedral, or plate-shaped. The crystallite size of the nonmagnetic powder preferably ranges from 4 nm 500 nm, more preferably from 40 to 100 nm. A crystallite size falling within a range of 4 nm to 500 nm is desirable in that it facilitates dispersion and imparts a suitable surface roughness. The average particle diameter of the nonmagnetic powder preferably ranges from 5 nm to 500 nm. As needed, nonmagnetic powders of differing average particle diameter may be combined; the same effect may be achieved by broadening the average particle distribution of a single nonmagnetic powder. The preferred average particle diameter of the nonmagnetic powder ranges from 10 to 200 nm. Within a range of 5 nm to 500 nm, dispersion is good and good surface roughness can be achieved.

The specific surface area of the nonmagnetic powder preferably ranges from 1 to 150 m²/g, more preferably from 20 to 120 m²/g, and further preferably from 50 to 100 m²/g. Within the specific surface area ranging from 1 to 150 m²/g, the nonmagnetic layer with suitable surface roughness can be formed and dispersion of nonmagnetic powder is possible with the desired quantity of binder. Oil absorption capacity using dibutyl phthalate (DBP) preferably ranges from 5 to 100 mL/100 g, more preferably from 10 to 80 mL/100 g, and further preferably from 20 to 60 mL/100 g. The specific gravity ranges from, for example, 1 to 12, preferably from 3 to 6. The tap density ranges from, for example, 0.05 to 2 g/mL, preferably from 0.2 to 1.5 g/mL. A tap density falling within a range of 0.05 to 2 g/mL can reduce the amount of scattering particles, thereby facilitating handling, and tends to prevent solidification to the device. The pH of the nonmagnetic powder preferably ranges from 2 to 11, more preferably from 6 to 9. When the pH falls within a range of 2 to 11, the coefficient of friction does not become high at high temperature or high humidity or due to the freeing of fatty acids. The moisture content of the nonmagnetic powder ranges from, for example, 0.1 to 5 weight percent, preferably from 0.2 to 3 weight percent, and more preferably from 0.3 to 1.5 weight percent. A moisture content falling within a range of 0.1 to 5 weight percent is desirable because it can produce good dispersion and yield a stable coating viscosity following dispersion. An ignition loss of equal to or less than 20 weight percent is desirable and nonmagnetic powders with low ignition losses are desirable.

When the nonmagnetic powder is an inorganic powder, the Mohs' hardness is preferably 4 to 10. Durability can be ensured if the Mohs' hardness ranges from 4 to 10. The stearic acid (SA) adsorption capacity of the nonmagnetic powder preferably ranges from 1 to 20 μmol/m², more preferably from 2 to 15 μmol/m². The heat of wetting in 25° C. water of the nonmagnetic powder is preferably within a range of 200 to 600 erg/cm² (approximately 200 to 600 mJ/m²). A solvent with a heat of wetting within this range may also be employed. The quantity of water molecules on the surface at 100 to 400° C. suitably ranges from 1 to 10 pieces per 100 Angstroms. The pH of the isoelectric point in water preferably ranges from 3 to 9. The surface of these nonmagnetic powders is preferably treated with Al₂O₃, SiO₂, TiO₂, ZrO₂, SnO₂, Sb₂O₃, and ZnO. The surface-treating agents of preference with regard to dispersibility are Al₂O₃, SiO₂, TiO₂, and ZrO₂, and Al₂O₃, SiO₂ and ZrO₂ are further preferable. They may be employed singly or in combination. Depending on the objective, a surface-treatment coating layer with a coprecipitated material may also be employed, the coating structure which comprises a first alumina coating and a second silica coating thereover or the reverse structure thereof may also be adopted. Depending on the objective, the surface-treatment coating layer may be a porous layer, with homogeneity and density being generally desirable.

Specific examples of nonmagnetic powders suitable for use in the nonmagnetic layer in the present invention are: Nanotite from Showa Denko K. K.; HIT-100 and ZA-G1 from Sumitomo Chemical Co., Ltd.; DPN-250, DPN-250BX, DPN-245, DPN-270BX, DPN-550BX and DPN-550RX from Toda Kogyo Corp.; titanium oxide TTO-51B, TTO-55A, TTO-55B, TTO-55C, TTO-55S, TTO-55D, SN-100, MJ-7, α-iron oxide E270, E271 and E300 from Ishihara Sangyo Co., Ltd.; STT-4D, STT-30D, STT-30 and STT-65C from Titan Kogyo K. K.; MT-100S, MT-100T, MT-150W, MT-500B, MT-600B, MT-100F and MT-500HD from Tayca Corporation; FINEX-25, BF-1, BF-10, BF-20 and ST-M from Sakai Chemical Industry Co., Ltd.; DEFIC-Y and DEFIC-R from Dowa Mining Co., Ltd.; AS2BM and TiO2P25 from Nippon Aerogil; 100A and 500A from Ube Industries, Ltd.; Y-LOP from Titan Kogyo K. K.; and sintered products of the same. Particular preferable nonmagnetic powders are titanium dioxide and α-iron oxide.

Carbon black may be combined with nonmagnetic powder in the nonmagnetic layer to reduce surface resistivity, reduce light transmittance, and achieve a desired micro-Vickers hardness. The micro-Vickers hardness of the nonmagnetic layer is normally 25 to 60 kg/mm² (approximately 245 to 588 MPa), desirably 30 to 50 kg/mm² (approximately 294 to 490 MPa) to adjust head contact. It can be measured with a thin film hardness meter (HMA-400 made by NEC Corporation) using a diamond triangular needle with a tip radius of 0.1 micrometer and an edge angle of 80 degrees as indenter tip. “Techniques for evaluating thin-film mechanical characteristics,” Realize Corp., for details. The content of the above publication is expressly incorporated herein by reference in its entirety. The light transmittance is generally standardized to an infrared absorbance at a wavelength of about 900 nm equal to or less than 3 percent. For example, in VHS magnetic tapes, it has been standardized to equal to or less than 0.8 percent. To this end, furnace black for rubber, thermal black for rubber, black for coloring, acetylene black and the like may be employed.

The specific surface area of the carbon black employed in the nonmagnetic layer is, for example, 100 to 500 m²/g, preferably 150 to 400 m²/g. The DBP oil absorption capability is, for example, 20 to 400 mL/100 g, preferably 30 to 200 mL/100 g. The particle diameter of the carbon black is, for example, 5 to 80 nm, preferably 10 to 50 nm, and more preferably, 10 to 40 nm. It is preferable that the pH of the carbon black is 2 to 10, the moisture content is 0.1 to 10 percent, and the tap density is 0.1 to 1 g/mL.

Specific examples of types of carbon black employed in the nonmagnetic layer are: BLACK PEARLS 2000, 1300, 1000, 900, 905, 800, 880, 700 and VULCAN XC-72 from Cabot Corporation; #3050B, #3150B, #3250B, #3750B, #3950B, #950, #650B, #970B, #850B and MA-600 from Mitsubishi Chemical Corporation; CONDUCTEX SC, RAVEN 8800, 8000, 7000, 5750, 5250, 3500, 2100, 2000, 1800, 1500, 1255 and 1250 from Columbia Carbon Co., Ltd.; and Ketjen Black EC from Ketjen Black International Co., Ltd.

The carbon black employed may be surface-treated with a dispersant or grafted with resin, or have a partially graphite-treated surface. The carbon black may be dispersed in advance into the binder prior to addition to the nonmagnetic coating liquid. These carbon blacks may be used singly or in combination. When employing carbon black, the quantity of the carbon black is preferably within a range not exceeding 50 weight percent of the inorganic powder as well as not exceeding 40 weight percent of the total weight of the nonmagnetic layer. For example, the Carbon Black Handbook compiled by the Carbon Black Association, which is expressly incorporated herein by reference in its entirety, may be consulted for types of carbon black suitable for use in the nonmagnetic layer.

Based on the objective, an organic powder may be added to the nonmagnetic layer. Examples of such an organic powder are acrylic styrene resin powders, benzoguanamine resin powders, melamine resin powders, and phthalocyanine pigments. Polyolefin resin powders, polyester resin powders, polyamide resin powders, polyimide resin powders, and polyfluoroethylene resins may also be employed. The manufacturing methods described in Japanese Unexamined Patent Publication (KOKAI) Showa Nos. 62-18564 and 60-255827 may be employed. The contents of the above applications are expressly incorporated herein by reference in their entirety.

Binder resins, lubricants, dispersing agents, additives, solvents, dispersion methods, and the like suited to the magnetic layer may be adopted to the nonmagnetic layer. In particular, known techniques for the quantity and type of binder resin and the quantity and type of additives and dispersion agents employed in the magnetic layer may be adopted thereto.

An undercoating layer can be provided between the nonmagnetic support and the nonmagnetic layer or the magnetic layer. Providing an undercoating layer can enhance adhesive strength between the support and the magnetic layer or nonmagnetic layer. For example, a polyester resin that is soluble in solvent can be employed as the undercoating layer.

### Layer Structure

In the magnetic recording medium manufactured by the manufacturing method of the present invention, the thickness of the nonmagnetic support preferably ranges from 3 to 80 micrometers, more preferably from 3 to 50 micrometers, further preferably from 3 to 10 micrometers. When an undercoating layer is provided between the nonmagnetic support and the nonmagnetic layer or the magnetic layer, the thickness of the undercoating layer ranges from, for example, 0.01 to 0.8 micrometer, preferably 0.02 to 0.6 micrometer.

The thickness of the magnetic layer will be described further below. The thickness variation in the magnetic layer is preferably within ±50 percent, more preferably within ±30 percent. At least one magnetic layer is sufficient. The magnetic layer may be divided into two or more layers having different magnetic characteristics, and a known configuration relating to multilayered magnetic layer may be applied.

The thickness of the nonmagnetic layer ranges from, for example, 0.1 to 3.0 μm, preferably 0.3 to 2.0 μm, and more preferably 0.5 to 1.5 μm. The nonmagnetic layer in the present invention is effective so long as it is substantially nonmagnetic. For example, it exhibits the effect of the present invention even when it comprises impurities or trace amounts of magnetic material that have been intentionally incorporated, and can be viewed as substantially having the same configuration as the magnetic recording medium in the present invention. The term “substantially nonmagnetic” is used to mean having a residual magnetic flux density in the nonmagnetic layer of equal to or less than 10 mT, or a coercive force Hc of equal to or less than 7.96 kA/m (100 Oe), it being preferable not to have a residual magnetic flux density or coercive force at all.

### Backcoat Layer

A backcoat layer can be formed on the opposite surface of the nonmagnetic support from the surface on which the magnetic layer is present. The backcoat layer preferably comprises carbon black and an inorganic powder. Formulas for the magnetic layer and nonmagnetic layer can be adopted to the binder and various additives for the backcoat layer. The thickness of the backcoat layer is preferably equal to or less than 0.9 micrometer, more preferably 0.1 to 0.7 micrometer.

### Physical Properties of the Magnetic Recording Medium

The various physical properties of the magnetic recording medium obtained by the manufacturing method of the present invention will be described below.

A magnetic recording medium in which the product, Mrδ, of the magnetic layer residual magnetization Mr and the magnet layer thickness δ is equal to or higher than 1 mA and equal to or lower than 8 mA can be obtained by the present invention. Mrδ is a value indicating the residual magnetization per unit area of the magnetic layer that can be measured with a vibrating sample fluxmeter made by Toei Industry Co., for example. When the Mrδ of the magnetic layer is equal to or greater than 1 mA, it becomes possible to obtain adequate magnetization during reproduction with a highly sensitive MR head, permitting better reproduction output. When the Mrδ is equal to or less than 8 mA, noise reduction becomes possible in the high-density recording region. It is also possible to avoid saturation of the magnetoresistive elements of the head. The Mrδ desirably falls within a range of 1 to 7 mA, preferably 2 to 6 mA.

The Mrδ can be controlled by means of the squareness and thickness of the magnetic layer. The thickness of the magnetic layer desirably ranges from 10 to 100 nm, as described further below, and the squareness in the longitudinal direction desirably ranges from 0.5 to 0.9. The desired Mrδ can be achieved by keeping the magnetic layer thickness and squareness within the above-stated ranges. Examples of methods that can be used to achieve the desired squareness are controlling the strength of the orientation magnetic field and the drying conditions, as well as controlling the dispersion level of the coating liquid. As set forth above, since orientation aggregation can be inhibited by the present invention, it is possible to form a magnetic layer in a desired orientation state with little aggregation.

The thickness of the magnetic layer formed by the manufacturing method of the present invention is desirably 10 to 100 nm. When the thickness of the magnetic layer is equal to or greater than 10 nm, a desired Mrδ can be readily achieved. The thickness of the magnetic layer is also desirably equal to or greater than 10 nm to form a uniform magnetic layer. Assuming the depth of the magnetic recording signal to be semicircular, the recording depth is generally about ¼ the recording wavelength. However, in reality, since there is also spacing loss, the depth that can be recorded is shallow, at about ⅙ to ⅛ the recording wavelength. Thus, when the thickness of the recording layer exceeds 100 nm, during high-density recording, such as at a linear recording density exceeding 100 kfci (λ=500 nm), the portion that is not recorded in the direction of depth of recording increases and noise increases. Thus, the thickness of the magnetic layer is desirably equal to or less than 100 nm. A thickness of less than 10 nm is undesirable in that formation of the magnetic layer becomes difficult, the effect of fluctuation at the interface with the nonmagnetic layer becomes pronounced, and noise increases. The thickness of the magnetic layer preferably falls within a range of 30 to 80 nm.

In the magnetic recording medium obtained by the manufacturing method of the present invention, the ratio (Sdc/Sac) of the average area Sdc of magnetic clusters in a DC demagnetized state to the average area Sac of magnetic clusters in an AC demagnetized state as measured by an magnetic force microscope (MFM) is desirably set to within a range of 0.8 to 2.0.

The “magnetic cluster area ratio” will be described below first.

It is widely known that in theory, low noise is achieved by a high fill ratio of microgranular magnetic particles. However, in particular, when microgranular magnetic particles are employed, there is a problem that the magnetic particles aggregate, creating entities that behave like single large magnetic material and compromise the S/N ratio. Magnetic blocks (referred to as “magnetic clusters” hereinafter) measured by a magnetic force microscope (MFM) correlate with medium noise and vary with the aggregation and magnetostatic bonding of the magnetic particles. A more detailed description will be given below.

The magnetic force microscope (MFM) permits the observation of leakage magnetic fields in minute spaces with a resolution of several tens of nanometers. That is, the magnetic force microscope (MFM) affords the feature of permitting the measurement of the state of magnetization of a magnetic recording medium at the submicron level. Generally, while applying an alternating magnetic field to a sample, the magnetic field is weakened stepwise to eliminate magnetization of the sample in what is known as alternating current (AC) demagnetization. Generally, individual magnetic materials will randomly orient themselves, total magnetization will approach zero, and the individual magnetic particles will exist in a nearly primary particle state while in an alternating current (AC) demagnetized state. Accordingly, magnetic clusters in an alternating current (AC) demagnetized state exhibit a nearly constant size, irrespective of the state of dispersion, that depends on the type of magnetic material (the size of the primary particle of the magnetic material and the saturation magnetization σs of the magnetic material) in the case of a magnetic particle medium.

Additionally, the method of applying a direct current and reducing the magnetic field to zero is called direct current (DC) demagnetization. In a direct current (DC) demagnetized state, residual magnetic fields within the sample is a combination of magnetization in the same orientation as the magnetic field that has been applied. Accordingly, the size of magnetic clusters in a direct current (DC) demagnetized state varies based on how magnetic particles are disposed within the medium, that is, based on their dispersion state. When an aggregate is present, it can be thought of as appearing to act as a single large magnetic particle. The size of magnetic clusters in a direct current (DC) demagnetized state corresponds to the size of the aggregates appearing to act as single large magnetic particles.

In an ideal state of dispersion, the aggregates would also disappear in a DC demagnetization state, and the magnetic clusters would be of the same size in both AC and DC demagnetized states. The larger the magnetic clusters in a DC demagnetized state relative to the size of the magnetic clusters in an AC demagnetized state, the greater the aggregation of the magnetic particles in the magnetic layer. That is, the value of Sdc/Sac serves as an indicator of the state of aggregation of magnetic particles in the magnetic layer.

Information on the aggregation state (dispersion) of the magnetic layer can also be obtained from just the size of the magnetic clusters in a DC magnetized state. However, for example, take a medium (sample α) in which A denotes the average area of the magnetic clusters in an AC demagnetized state and B denotes the average area of the magnetic clusters in a DC demagnetized state, and a medium (sample β) in which the average area of the magnetic clusters in an AC demagnetized state is 2 A (=twice that in sample α), but in which the dispersion is increased to a higher level than in sample α to inhibit aggregation, resulting in an average area of magnetic clusters in a DC demagnetized state of B, just as in sample α. A comparison of just the average area Sdc of magnetic clusters in a DC demagnetized state would yield the same value for both, despite the dispersion state of sample β actually being superior. That is, the area of magnetic clusters in a DC demagnetized state can change with the type of magnetic material, such as the size of the magnetic material.

By contrast, Sdc/Sac in sample α would be “B/A,” and Sdc/Sac in sample β would be “B/2A,” with the Sdc/Sac of sample β being ½ that of sample α.

By adopting the ratio of Sdc/Sac in this manner, when the Sdc of two samples is identical despite different states of dispersion, a difference occurs due to the difference in dispersion. That is, taking the ratio of Sdc/Sac affords an indicator of the standardized aggregation state (dispersion) that is not affected by the type of magnetic material.

The ratio (Sdc/Sac) of the average area Sdc of magnetic clusters in a DC demagnetized state to the average area Sac of magnetic clusters in an AC demagnetized state falling within a range of 0.8 to 2.0 is desirable to obtain a good S/N ratio. When Sdc/Sac is equal to or less than 2.0, it is possible to achieve a good S/N ratio with little noise. In the case of an ideal dispersion state, Sac and Sdc would match and Sdc/Sac would become 1. Thus, the closer Sdc/Sac is to 1, the closer the state is to no aggregation. However, since the magnetic cluster size is measured by a magnetic force microscope (MFM) and there is some measurement error, when this measurement error is taken into account, the lower limit essentially becomes 0.8. The above ratio is desirably 0.8 to 1.7, preferably 0.8 to 1.5.

As set forth above, the average area Sac of magnetic clusters in an AC demagnetized state is determined by the diameter of the primary magnetic particles, and the average area Sdc of magnetic clusters in a DC demagnetized state basically depends on the dispersion of the magnetic particles and dispersion stability. Both Sdc and Sac are desirably within a range of 3,000 to 50,000 nm², preferably a range of 3,000 to 35,000 nm², and more preferably, within a range of 3,000 to 20,000 nm². When both Sdc and Sac are equal to or greater than 3,000 nm², magnetization is not destabilized by thermal fluctuation, and when equal to or less than 50,000 nm², a small unit of reversal of magnetization and a high resolution can be achieved during high-density recording.

Since Sdc can vary with the dispersibility of the magnetic layer, it is possible to achieve a desired Sdc/Sac by controlling the Sdc value by means of the dispersibility of the magnetic layer. A magnetic recording medium having a desired Sdc/Sac can be obtained in the present invention through the above-described steps. Since orientation aggregation can be suppressed by conducting the above-described steps, it is possible to conduct orientation processing while the magnetic layer is wet to achieve a desired orientation state, and obtain a magnetic recording medium of reduced aggregation.

When applying the present invention to a magnetic recording medium of multilayered structure, the method of coating the magnetic layer once the nonmagnetic layer has dried (wet-on-dry) is desirably employed to inhibit aggregation and lower the Sdc. In the case where multiple layers are coated while the magnetic layer and nonmagnetic layer are both wet (wet-on-wet), it is desirable to impart a shear to the coating liquid within the coating head by the method disclosed in Japanese Unexamined Patent Publication (KOKAI) Showa No. 62-95174 or Heisei No. 1-236968 to prevent a drop in the electromagnetic characteristics of the magnetic recording medium due to the aggregation of magnetic particles. The contents of these applications are expressly incorporated herein by reference in their entirety.

The saturation magnetic flux density of the magnet layer is preferably 100 to 400 mT. The coercivity (Hc) of the magnetic layer is preferably 143.2 to 318.3 kA/m (approximately 1,800 to 4,000 Oe), more preferably 159.2 to 278.5 kA/m (approximately 2,000 to 3,500 Oe). Narrower coercivity distribution is preferable. The SFD and SFDr are preferably equal to or lower than 0.6, more preferably equal to or lower than 0.3.

The coefficient of friction of the magnetic recording medium relative to the head is, for example, equal to or less than 0.5 and preferably equal to or less than 0.3 at temperatures ranging from −10° C. to 40° C. and humidity ranging from 0 percent to 95 percent, the surface resistivity on the magnetic surface preferably ranges from 10⁴ to 10⁸ ohm/sq, and the charge potential preferably ranges from −500 V to +500 V. The modulus of elasticity at 0.5 percent extension of the magnetic layer preferably ranges from 0.98 to 19.6 GPa (approximately 100 to 2,000 kg/mm²) in each in-plane direction. The breaking strength preferably ranges from 98 to 686 MPa (approximately 10 to 70 kg/mm²). The modulus of elasticity of the magnetic recording medium preferably ranges from 0.98 to 14.7 GPa (approximately 100 to 1500 kg/mm²) in each in-plane direction. The residual elongation is preferably equal to or less than 0.5 percent, and the thermal shrinkage rate at all temperatures below 100° C. is preferably equal to or less than 1 percent, more preferably equal to or less than 0.5 percent, and most preferably equal to or less than 0.1 percent.

The glass transition temperature (i.e., the temperature at which the loss tangent of dynamic viscoelasticity peaks as measured at 110 Hz) of the magnetic layer preferably ranges from 50 to 180° C., and that of the nonmagnetic layer preferably ranges from 0 to 180° C. The loss elastic modulus preferably falls within a range of 1×10⁷ to 8×10⁸ Pa (approximately 1×10⁸ to 8×10⁹ dyne/cm²) and the loss tangent is preferably equal to or less than 0.2. Adhesion failure tends to occur when the loss tangent becomes excessively large. These thermal characteristics and mechanical characteristics are desirably nearly identical, varying by equal to or less than 10 percent, in each in-plane direction of the medium.

The residual solvent contained in the magnetic layer is preferably equal to or less than 100 mg/m² and more preferably equal to or less than 10 mg/m². The void ratio in the coated layers, including both the nonmagnetic layer and the magnetic layer, is preferably equal to or less than 30 volume percent, more preferably equal to or less than 20 volume percent. Although a low void ratio is preferable for attaining high output, there are some cases in which it is better to ensure a certain level based on the object. For example, in many cases, larger void ratio permits preferred running durability in disk media in which repeat use is important.

When manufacturing a magnetic recording medium comprising a nonmagnetic layer and a magnetic layer, physical properties of the nonmagnetic layer and magnetic layer may be varied based on the objective. For example, the modulus of elasticity of the magnetic layer may be increased to improve running durability while simultaneously employing a lower modulus of elasticity than that of the magnetic layer in the nonmagnetic layer to improve the head contact of the magnetic recording medium.

### Coating Step, Orientation Processing, and Calendering Step

The method of manufacturing a magnetic recording medium of the present invention can comprise, for example, a step of obtaining a coated stock material by coating a magnetic layer coating liquid containing ferromagnetic powder and binder on at least one surface of a nonmagnetic support following the various above-described steps; a step of winding the coated stock material on a take-up roll; and a step of unwinding the coated stock material that has been wound on the take-up roll and subjecting it to calendering. In the coating step, for example, the magnetic layer is formed by coating the magnetic layer coating liquid to a prescribed film thickness on the surface of the nonmagnetic support while the nonmagnetic support is running. Multiple magnetic layer coating liquids can be successively or simultaneously coated in a multilayer coating, and the nonmagnetic layer coating liquid and the magnetic layer coating liquid can be successively or simultaneously coated in a multilayer coating. To achieve a desired Sdc/Sac as set forth above, the nonmagnetic layer coating liquid and magnetic layer coating liquid are desirably successively coated in a multilayer coating (wet-on-dry).

Coating machines suitable for use in coating the magnetic layer and nonmagnetic layer coating liquids are air doctor coaters, blade coaters, rod coaters, extrusion coaters, air knife coaters, squeeze coaters, immersion coaters, reverse roll coaters, transfer roll coaters, gravure coaters, kiss coaters, cast coaters, spray coaters, spin coaters, and the like. For example, “Recent Coating Techniques” (May 31, 1983), issued by the Sogo Gijutsu Center K.K., which is expressly incorporated herein by reference in its entirety, may be referred to in this regard.

The coating film formed by coating the magnetic layer coating liquid is subjected to orientation processing while still wet in the present invention. The magnetic recording medium that is manufactured by the present invention can be a magnetic tape such as a video tape or computer tape, or a magnetic disk such as a flexible disk or hard disk. When it is a magnetic tape, the hexagonal ferrite contained in the coating film that is formed by coating the magnetic layer coating liquid can be subjected to magnetic field orientation processing with cobalt magnets or solenoids. A suitable preliminary drying step can be provided prior to orientation. A drying step is desirably provided during orientation to inhibit reversion from orientation. Cobalt magnets or solenoid magnets of equal to or greater than 0.1 T are desirable. A targeted orientation can be obtained by varying the coating rate and concentration of the magnetic layer coating liquid. When it is a disk, a known random orientation device is desirably employed, such as one in which cobalt magnets are alternately arranged diagonally, or alternating fields are applied by solenoids.

When the magnetic recording medium obtained by the present invention is a magnetic tape, the squareness (residual magnetization/saturation magnetization) in the longitudinal direction is desirably 0.5 to 0.9. Within the above range, noise is low, output can be ensured, and a good S/N ratio can be achieved. The squareness in the longitudinal direction is preferably 0.6 to 0.9. When a magnetic disk, the squareness in the longitudinal direction is desirably 0.3 to 0.7, and is desirably isotropic within the surface.

The drying position of the coating is desirably controlled by controlling the temperature and flow rate of drying air, and coating speed. A coating speed of 20 m/min to 1,000 m/min and a dry air temperature of equal to or higher than 60° C. are desirable. Suitable predrying can be conducted prior to entry into the magnet zone.

The coated stock material thus obtained can be normally temporarily wound on a take-up roll, and then unwound from the take-up roll and calendered.

For example, super calender rolls can be employed in calendering. Calendering can enhance surface smoothness, eliminate voids produced by the removal of solvent during drying, and increase the fill rate of the ferromagnetic powder in the magnetic layer, thus yielding a magnetic recording medium of good electromagnetic characteristics. The calendering step is desirably conducted by varying the calendering conditions based on the smoothness of the surface of the coated stock material.

The glossiness of the coated stock material may decrease roughly from the center of the take-up roll toward the outside, and there is sometimes variation in the quality in the longitudinal direction. Glossiness is known to correlate (proportionally) to the surface roughness Ra. Accordingly, when the calendering conditions are not varied in the calendering step, such as by maintaining a constant calender roll pressure, there is no countermeasure for the difference in smoothness in the longitudinal direction resulting from winding of the coated stock material, and the variation in quality in the longitudinal direction tends to carry over into the final product.

Accordingly, in the calendering step, it is desirable to vary the calendering conditions, such as the calender roll pressure, to cancel out the different in smoothness in the longitudinal direction that is produced by winding of the coated stock material. Specifically, it is desirable to reduce the calender roll pressure from the center to the outside of the coated stock material that is wound off the take-up roll. Based on an investigation by the present inventors, lowering the calender roll pressure decreases the glossiness (smoothness diminishes). Thus, the difference in smoothness in the longitudinal direction that is produced by winding of the coated stock material is cancelled out, yielding a final product free of variation in quality in the longitudinal direction.

An example of changing the pressure of the calender rolls has been described above to control the surface smoothness. Additionally, it is possible to control the surface smoothness by means of the calender roll temperature, calender roll speed, and calender roll tension. Taking into account the properties of a particulate medium, it is desirable to control the surface smoothness by means of the calender roll pressure and calender roll temperature. Generally, the calender roll pressure is reduced, or the calender roll temperature is lowered, to diminish the surface smoothness of the final product. Conversely, the calender roll pressure can be increased or the calender roll temperature can be raised to increase the surface smoothness of the final product.

Alternatively, the magnetic recording medium obtained following the calendering step can be thermally processed to promote thermal curing. Such thermal processing can be suitably determined based on the blending formula of the magnetic layer coating liquid. The thermal processing temperature is, for example, 35 to 100° C., desirably 50 to 80° C. The thermal processing time is, for example, 12 to 72 hours, desirably 24 to 48 hours.

Rolls of a heat-resistant plastic such as epoxy, polyimide, polyamide, or polyamidoimide, can be employed as the calender rolls. Processing with metal rolls is also possible.

It is desirable for the magnetic recording medium obtained by the present invention to have extremely good smoothness in the form of a center surface average roughness of the magnetic layer surface (at a cutoff value of 0.25 mm) of 0.1 to 4 nm, preferably within a range of 1 to 3 nm. The calendering conditions required to achieve this are as follows. The calender roll temperature desirably ranges from 60 to 100° C., preferably ranges from 70 to 100° C., and more preferably ranges from 80 to 100° C. The pressure desirably ranges from 100 to 500 kg/cm (98 to 490 kN/m), preferably ranges from 200 to 450 kg/cm (196 to 441 kN/m), and more preferably, ranges from 300 to 400 kg/cm (294 to 392 kN/m).

The magnetic recording medium obtained can be cut to desired size with a cutter or the like for use. The cutter is not specifically limited, but desirably comprises multiple sets of a rotating upper blade (male blade) and lower blade (female blade). The slitting speed, engaging depth, peripheral speed ratio of the upper blade (male blade) and lower blade (female blade) (upper blade peripheral speed/lower blade peripheral speed), period of continuous use of slitting blade, and the like are suitably selected.

### Magnetic Recording Medium

The present invention further relates to a magnetic recording medium manufactured by the manufacturing method of the present invention. Details of thew magnetic recording medium of the present invention are as set forth above.

The magnetic recording medium of the present invention is suited to magnetic recording and reproduction systems employing MR heads with higher sensitivity than conventional MR heads, specifically, highly sensitive AMR heads or giant magnetoresistive (GMR) heads, as reproduction heads. It is particularly suited to magnetic recording and reproduction systems employing GMR heads as reproduction heads. GMR heads employ a magnetoresistive effect corresponding to the size of the magnetic flux exerted on thin-film magnetic heads, affording the advantage of yielding a reproduction output higher than what can be achieved with inductive heads. This is primarily because, since the reproduction output of GMR heads is based on the change in magnetic resistance, it is not dependent on the relative speed of the head and the disk, making it possible to achieve a higher output than inductive magnetic heads. Reading sensitivity is about three times higher than that of conventional AMR heads. The use of such a GMR head as the reproduction head permits excellent reproduction characteristics in the high frequency region.

When the magnetic recording medium of the present invention is in the form of a tape-shaped magnetic recording medium, the use of a GMR head as reproduction head permits reproduction at a high S/N ratio even when the signal has been recorded in a higher frequency region than is conventionally the case. Accordingly, the magnetic recording medium of the present invention is optimal as a magnetic recording medium in either magnetic tape or disk form for use in high-density recording of computer data.

The manufacturing method of the present invention can yield a magnetic recording medium in which increased noise and output drop due to the medium are inhibited. The magnetic recording medium of the present invention that is obtained by the above-described manufacturing method can yield a high S/N ratio in high-density recording.

Normally, two units denoting linear recording density are employed: fci and bpi. “fci” denotes the density that is physically recorded on the medium as the number of bit reversals per inch, while “bpi” denotes the number of bits per inch, including signal processing, and is system-dependent. Thus, the fci is normally employed for pure performance evaluation of a medium. The desirable linear recording density range in the course of recording a signal on the magnetic recording medium of the present invention is 100 to 400 kfci, with 175 to 400 kfci being preferred. In systems actually in use, this depends on signal processing, and cannot be determined once and for all. As a general guideline, performance is reflected by an fci of 0.5 to one times the bpi. Thus, a range of 200 to 800 kbpi is desirable, 350 to 800 kbpi being particularly preferred.

The reproduction head employed for reproduction of magnetic signals that have been recorded on the magnetic recording medium of the present invention is desirably a GMR head. With GMR heads, highly sensitive reproduction is possible even at a reproduction track width is set to equal to or less than 3 micrometers (desirably 0.1 to 3 micrometers), for example, to reproduce signals that have been recorded at high density. Further, with the magnetic recording medium of the present invention, it is possible to achieve a good S/N ratio during reproduction with GMR heads. That is, the use of the magnetic recording medium of the present invention with a GMR head permits the reproduction with a good S/N ratio of signals recorded at high density.

A highly sensitive AMR head can be also employed as the reproduction head. Generally, the coefficient of magnetoresistance is employed as the indicator of sensitivity of a head. Commonly employed magnetoresistive elements have a coefficient of magnetoresistance of about 2 percent at a thickness of 200 to 300 nm. By contrast, it is about 2 to 5 percent for highly sensitive AMR heads. When employing a highly sensitive AMR head, it is also possible to reproduce with high sensitivity signals that have been recorded on the magnetic recording medium of the present invention to achieve a high S/N ratio.

### EXAMPLES

The present invention will be described in detail below based on Examples. However, the present invention is not limited to the embodiments described in Examples. The term “parts” given in Examples are weight parts.

Magnetic layer coating liquid components

| | | |
|---|---|---|
| Hexagonal barium ferrite powder | 100 | parts |
| Surface treatment agent: Al₂O₃ | | |
| Hc: 191 kA/m (approximately 2400 Oe) | | |
| Average plate diameter: 25 nm, average plate ratio: 3.0 | | |
| σs: 50 A · m²/kg (approximately50 emu/g) | | |
| Polyurethane resin based on branched side chain- | 15 | parts |
| comprising polyester polyol/diphenylmethane diisocyanate, | | |
| —SO₃Na = 400 eq/ton | | |
| α-Al₂O₃ (particle size: 0.15 micrometer) | 4 | parts |
| Plate-shaped alumina powder (average particle | 0.5 | part |
| diameter: 50 nm) | | |
| Diamond powder (average particle diameter: 60 nm) | 0.5 | part |
| Carbon black (particle size: 20 nm) | 1 | part |
| Cyclohexanone | 110 | parts |
| Methyl ethyl ketone | 100 | parts |
| Toluene | 100 | parts |
| Butyl stearate | 2 | parts |
| Stearic acid | 1 | part |

Nonmagnetic layer coating liquid components

| | | |
|---|---|---|
| Nonmagnetic inorganic powder | 85 | parts |
| α-iron oxide | | |
| Surface treatment agent: Al₂O₃, SiO₂ | | |
| Major axis diameter: 0.15 micrometer | | |
| Tap density: 0.8 | | |
| Acicular ratio: 7 | | |
| Specific surface area by BET method: 52 m²/g | | |
| pH: 8 | | |
| DBP oil absorption capacity: 33 g/100 g | | |
| Carbon black | 15 | parts |
| DBP oil absorption capacity: 120 mL/100 g | | |
| pH: 8 | | |
| Specific surface area by BET method: 250 m²/g | | |
| Volatile content: 1.5 percent | | |
| Polyurethane resin based on branched side chain- | 22 | parts |
| comprising polyester polyol/diphenylmethane diisocyanate, | | |
| —SO₃Na = 200 eq/ton | | |
| Phenylphosphonic acid | 3 | parts |
| Cyclohexanone | 140 | parts |
| Methyl ethyl ketone | 170 | parts |
| Butyl stearate | 2 | part |
| Stearic acid | 1 | part |

Backcoat layer coating liquid components

| | | |
|---|---|---|
| Carbon black (average particle diameter: 25 nm) | 40.5 | parts |
| Carbon black (average particle diameter: 370 nm) | 0.5 | part |
| Barium sulfate | 4.05 | parts |
| Nitrocellulose | 28 | parts |
| SO₃Na group-containing polyurethane resin | 20 | parts |
| Cyclohexanone | 100 | parts |
| Toluene | 100 | parts |
| Methyl ethyl ketone | 100 | parts |

The components of the above-described nonmagnetic layer coating liquid and the components of the backcoat layer coating liquid were separately kneaded in open kneaders and dispersed using 0.5 mm Zr bead mills (720 minutes for the nonmagnetic layer coating liquid and 720 minutes for the backcoat layer coating liquid). To each of the dispersion liquids obtained were added four parts of trifunctional low-molecular-weight polyisocyanate compound (Coronate 3041 made by Nippon Polyurethane Industry Co.), and the mixtures were stirred for another 20 minutes. Subsequently, the mixtures were filtered using a filter having an average pore diameter of 0.5 micrometer.

The magnetic layer coating liquid was produced by the four methods shown in Table 1. An NJ-100 Model Nanojet Miser made by Aishin Nanotechnologies was employed in dry comminution. The comminution conditions were: a barium ferrite introduction rate of 8 kg/hour, a barium ferrite introduction pressure of 1.45 MPa, and a comminution pressure of 1.45 MPa.

In methods (1) and (2), the barium ferrite magnetic powder (which, in (2), was subjected to dry comminution processing) was kneaded in an open kneader with other components of the magnetic layer coating liquid, dispersed (bead dispersion) for 1,440 minutes in a 0.5 mm Zr bead mill, and then filtered with a filter having an average pore diameter of 0.5 micrometer.

In method (3), magnetic powder that had been dry comminution processed was processed in an ultrasonic homogenizer (processing conditions: frequency: 20 KHz, output: 600 W, processing time: 30 minutes) with the other components of the magnetic layer coating liquid, after which the same methods of bead dispersion and filtration were employed as in methods (1) and (2).

In method (4), magnetic powder that had been dry comminution processed was processed by stirring in a disper with the other components of the magnetic layer coating liquid, after which the same methods of bead dispersion and filtration were employed as in methods (1) and (2).

TABLE 1

| | Dry comminution | First dispersion | Second dispersion |
|---|---|---|---|
| | step | step | step |
| Method (1) | Not conducted | Open kneader | Bead dispersion |
| Method (2) | Conducted | Open kneader | Bead dispersion |
| Method (3) | Conducted | Ultrasonic | Bead dispersion |
| | | dispersion | |
| Method (4) | Conducted | Disper stirring | Bead dispersion |

A. Evaluation of Hexagonal Ferrite following the Comminution Step

Portions of the barium ferrite that had been dry comminution processed in above-described methods (2) to (4) were collected as evaluation samples. The specific surface area S_{BET} by the BET method, stearic acid adsorption capacity, and the passage rate through 150 micrometer mesh were measured by the methods set forth below. A prescribed quantity of hexagonal ferrite was collected from the barium ferrite remaining after collection of the evaluation samples and subjected to the first step. For method (1), a portion of the starting material barium ferrite was collected, the same measurement was conducted, and a prescribed quantity of hexagonal ferrite was collected from the remaining barium ferrite and subjected to the first step.

1. S_{BET} Measurement Method

A 0.1 g quantity of evaluation sample was measured by the Bet 1 point method with a Sorptometers 1040 made by Bel Japan, Inc.

2. Method of Measuring the Stearic Acid Adsorption Capacity

Three gram quantities of sample were added to 50 mL solutions of 0.1, 0.05, and 0.02 mol/L concentrations of stearic acid in methyl ethyl ketone (MEK), the mixtures were stirred with a magnetic stirrer for 20 hours at 25° C. to induce adsorption, and solid-liquid separation was conducted. Subsequently, the unadsorbed stearic acid in the supernatant was titrated with a 0.03 mol KOH ethanol solution and the saturation absorption level was calculated by the Langmuir equation from the quantity adsorbed.

3. Method of Measuring the Passage Rate through 150 Micrometer Mesh

A 100 g quantity of evaluation sample was sieved with a 150 micrometer mesh. The quantity of hexagonal ferrite passing through the mesh was measured to obtain the passage rate through the mesh.

The results of the above are given in Table 2. The hexagonal ferrite following the comminution step was subjected to the above-described measurement and first dispersion step within the above-described period during which no variation in measurement values was observed. Thus, the values given in Table 2 can be considered to be the values exhibited by the hexagonal ferrite when subjected to the first step.

B. Evaluation of the Dispersion Liquid following the First Step

In methods (1) to (4), portions of the dispersion liquids obtained in the first dispersion step were collected as evaluation samples and the amount of binder adsorbed to the barium ferrite and the amount of dry solid component as measured after filtration were measured by the following methods.

1. Amount of Binder Absorption

A 10 g quantity of evaluation sample was centrifugally separated, the quantity of binder remaining in the supernatant was obtained from the concentration of solid component, and the difference with the binder added was calculated as the amount adsorbed.

2. Amount of Dry Solid Component After Filtration

To 100 g of evaluation sample was added 200 g of methyl ethyl ketone. The mixture was passed through a filter having an average pore diameter of 1.0 micrometer; the solid matter remaining on the filter was recovered, dried and weighed; and the (amount of dry solid matter following recovery/amount of solid component of coating liquid)×100 was calculated.

The results of the above are given in Table 3. Since the dispersion liquid following the first dispersion step was subjected to the above-described measurement and second dispersion step within the above-described period during which no variation in the above-described measurement values was observed, the values given in Table 3 can be considered to be the values exhibited by the dispersion when subjected to the second step.

C. Evaluation of the Coating Liquid following the Filtering Step

Portions of the coating liquids obtained following the filtering step in methods (1) to (4) were collected as evaluation samples and the following evaluation was conducted.

1. D50

A 0.5 g quantity of evaluation sample was diluted 100-fold with a 3:2 solvent of methyl ethyl ketone:cyclohexanone and an LB500 dynamic light scattering particle size analyzer made by Horiba was employed to obtain the D50 value corresponding to 50 percent of the cumulative volume.

2. Coating Film Surface Properties (the Center Surface Average Roughness Ra of a Coating Film on a Surface with Ra=3.6 nm)

The evaluation sample was coated in a quantity calculated to yield a dry film of 1 micrometer to an Ra 3.6 nm base and the Ra was determined by the following method.

Measurement at a scan length of 5 micrometers was conducted by the scanning white light interference method with a NewView 5022 general-purpose 3D surface profiler made by ZYGO Corp. The measurement field was 260×350 micrometers. The surface measured was filter processed with a HPF of 1.65 micrometers and a LPF of 50 micrometers. The SRa was measured in 10 spots and the average value was employed.

The results of the above are given in Table 4. Since the coating liquid obtained following the filtering step was subjected to the above-described measurement and coating step within the above-described period during which no variation in the measurements values was observed, the values given in Table 4 can be considered to be the values exhibited by the coating liquid when subjected to the coating step.

TABLE 2
Results of Evaluation A

| | | State of hexagonal ferrite | | |
|---|---|---|---|---|
| | | | | Passage rate |
| | Dry | | Stearic acid | through 150 |
| | comminution | S_{BET} | adsorption capacity | micrometer |
| | step | m²/g | μmol/m² | mesh % |
| Method (1) | Not conducted | 67.1 | 6.0 | 31 |
| Method (2) | Conducted | 99.9 | 8.9 | 100 |
| Method (3) | Conducted | 99.9 | 8.9 | 100 |
| Method (4) | Conducted | 99.9 | 8.9 | 100 |

TABLE 3
Results of Evaluation B

| | State of dispersion liquid following | |
|---|---|---|
| | second dispersion step | |
| | Amount of binder absorption | |
| | weight parts per 100 | Amount |
| | weight parts of | of dry solid component |
| | hexagonal ferrite | after filtration % |
| Method (1) | 9.5 | 31 |
| Method (2) | 10.1 | 1 |
| Method (3) | 10.5 | 5 |
| Method (4) | 10.6 | 12 |

TABLE 3
Results of Evaluation C

State of dispersion liquid
following filtering step

| | | Ra |
|---|---|---|
| | D50 % | nm |
| Method (1) | 45 | 2.8 |
| Method (2) | 38 | 2.3 |
| Method (3) | 32 | 2.4 |
| Method (4) | 34 | 2.4 |

Fabrication of Magnetic Tape

The nonmagnetic layer coating liquid obtained was coated to a polyethylene naphthalate support 5 micrometers in thickness with an average surface roughness Ra=1.5 nm (as measured with an HD2000 made by WYKO) and dried at 100° C. Subsequently, a magnetic layer coating liquid (see Table 5) prepared by one of the methods of (1) to (4) was coated in a wet-on-dry coating on the nonmagnetic layer to achieve the dry thickness indicated in Table 5 and dried at 100° C. A seven-stage calender comprised solely of metal rolls was then employed to conduct processing at 100 m/minute, 90° C., and a linear pressure of 300 kg/cm. The product was slit to a width of ½ inch to obtain a magnetic tape. Oriented products were obtained by orientation with cobalt magnets having a magnetic force of 0.3 T followed by orientation with solenoids having a magnetic force of 0.15 T (the SQ was adjusted by varying the solenoid residence period) while the coating film was still wet following coating of the magnetic layer coating liquid.

Methods of Medium Evaluation

### 1. Magnetic Clusters

A sample that had been demagnetized in an alternating current magnetic field and a sample that had been direct-current demagnetized with an external magnetic field of 796 kA/m (10 kOe) using a vibrating sample fluxmeter (made by Toei Industry Co.) were measured at a lift height of 40 nm over a range of 5×5 micrometers with a Nanoscope III made by Digital Instruments in MFM mode to obtain magnetic force images. The threshold was set to 70 percent of the standard deviation (rms) value of the magnetic force distribution, the images were converted to binary, and only portions having a magnetic force of equal to or greater than 70 percent were displayed. The image was inputted to an image analyzer (K2-400 made by Carl Zeiss). After removing the noise and filling holes, the average area was calculated. Ten spots were measured and the average value was calculated.

### 2. SQ in the Longitudinal Direction

Measurement was conducted at an externally applied magnetic field intensity Hm of 796 kA/m (approximately 10 kOe) with a vibration sample fluxmeter VSM (made by Toei Industry Co.). The direction of the magnetic field Hm applied was the longitudinal direction of the tape. The level of residual magnetization/level of saturation magnetization was adopted as the SQ in the longitudinal direction.

### 3. Electromagnetic Characteristics (Reproduction Output, Noise, and S/N Ratio)

The electromagnetic characteristics were measured with a drum tester (relative speed 2 m/s) and measurements were conducted by the following methods. A write head with a gap length of 0.2 micrometer and Bs=1.7 T was employed. The ratio of the output at a linear recording density of 200 kfci (recording wavelength of 254 nm) to the integral noise at 0 to 400 kfci was measured.

### 4. Mrδ

Measurement was conducted at an externally applied magnetic field intensity Hm of 796 kA/m (approximately 10 kOe) with a vibration sample fluxmeter VSM (made by Toei Industry Co.). The direction of the magnetic field Hm applied was the longitudinal direction of the tape.

The results of the above are given in Table 5.

| | Method of | | | | | | | | |
|---|---|---|---|---|---|---|---|---|---|
| | preparing magnetic | Orietnation | | | Longitudinal | | Reproduction | Noise | SNR |
| | layer coating liquid | processing | δ (nm) | Mr δ (mA) | SQ | Sdc/Sac | output (dB) | (dB) | (dB) |
| Comp. Ex. 1 | Method (1) | Not conducted | 60 | 2.5 | 0.42 | 1.50 | 0 | 0 | 0 |
| Comp. Ex. 2 | Method (1) | Conducted | 60 | 3.4 | 0.57 | 2.30 | 1 | 0.9 | 0.1 |
| Comp. Ex. 3 | Method (1) | Conducted | 90 | 7.0 | 0.78 | 2.40 | 1.2 | 1.4 | −0.2 |
| Comp. Ex. 4 | Method (2) | Not conducted | 60 | 2.3 | 0.38 | 0.85 | −1.4 | −1.6 | 0.2 |
| Ex. 1-1 | Method (2) | Conducted | 30 | 2.6 | 0.87 | 1.23 | 1.5 | −1.3 | 2.8 |
| Ex. 1-2 | Method (2) | Conducted | 30 | 2.2 | 0.74 | 1.40 | 0.9 | −1.5 | 2.4 |
| Ex. 1-3 | Method (2) | Conducted | 30 | 1.5 | 0.50 | 1.33 | 0.5 | −1.5 | 2 |
| Ex. 2-1 | Method (2) | Conducted | 60 | 5.3 | 0.89 | 1.32 | 2 | −1.3 | 3.3 |
| Ex. 2-2 | Method (2) | Conducted | 60 | 4.3 | 0.72 | 1.21 | 1.7 | −1.3 | 3 |
| Ex. 2-3 | Method (2) | Conducted | 60 | 3.0 | 0.50 | 1.17 | 0.8 | −1.2 | 2 |
| Ex. 3-1 | Method (2) | Conducted | 90 | 8.0 | 0.89 | 0.89 | 1.8 | −0.4 | 2.2 |
| Ex. 3-2 | Method (2) | Conducted | 90 | 6.3 | 0.70 | 0.93 | 0.2 | −0.5 | 0.7 |
| Ex. 3-3 | Method (2) | Conducted | 90 | 4.5 | 0.50 | 0.98 | 0.5 | −0.8 | 1.3 |
| Ex. 4 | Method (3) | Conducted | 60 | 4.5 | 0.75 | 0.90 | 1.9 | −1.5 | 3.4 |
| Ex. 5 | Method (4) | Conducted | 60 | 4.3 | 0.72 | 0.95 | 1.5 | −1.6 | 3.1 |

Evaluation Results

As indicated in Table 5, the magnetic tapes of Examples fabricated with magnetic layer coating liquids prepared by the methods of (2) to (4) exhibited little aggregation even when SQ adjustment was conducted by orientation processing, achieving Sdc/Sac ratios falling within the range of 0.8 to 2.0. The magnetic tapes of Examples afforded low noise and good electromagnetic characteristics. It will be understood from a comparison of Examples 2-1 to 2-3 and Comparative Example 4 that a desired SQ could be obtained by orientation processing.

Further, in magnetic tapes fabricated with magnetic layer recording liquids prepared by conducting no dry comminution processing, the Sdc/Sac ratio fell within the range of 0.8 to 2.0 without orientation processing (Comparative Example 1), but exceeded 2.0 when orientation processing was conducted (Comparative Examples 2 and 3). It will thus be understood that aggregation (orientation aggregation) was produced by orientation processing.

The magnetic recording medium of the present invention can be suitably employed in magnetic recording and reproduction systems in which signals are reproduced with highly sensitive MR heads.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. A method of manufacturing a magnetic recording medium comprising:
coating a magnetic layer coating liquid comprising a ferromagnetic hexagonal ferrite powder and a binder directly or indirectly on a nonmagnetic support to form a coating film,
subjecting the coating film to orientation processing while the coating film is still wet, and
drying the coating film to form a magnetic layer, wherein
the magnetic layer coating liquid is prepared by:
subjecting a ferromagnetic hexagonal ferrite powder with an average plate diameter ranging from 10 to 50 nm to a dry comminution step,
subjecting the ferromagnetic hexagonal ferrite powder obtained by the dry comminution step to a first dispersion step together with a binder to prepare a dispersion liquid, and
sequentially subjecting the dispersion liquid obtained by the first dispersion step to a second dispersion step and a filtering step, the dispersion liquid obtained by the first dispersion step comprising a dry solid component in an amount, as measured after filtration, of equal to or less than 15 percent.

2. The method of manufacturing a magnetic recording medium according to claim 1, wherein a surface of a coating film formed by coating the magnetic layer coating liquid on a surface with a center surface average roughness Ra of 3.6 nm has a center surface average roughness Ra of equal to or less than 2.5 nm.

3. The method of manufacturing a magnetic recording medium according to claim 1, wherein a particle size, D50, of 50 percent of the cumulative volume in the magnetic layer coating liquid is equal to or less than 40 nm.

4. The method of manufacturing a magnetic recording medium according to claim 1, wherein the dry comminution step is carried out with a spiral flow jet mill.

5. The method of manufacturing a magnetic recording medium according to claim 1, wherein the ferromagnetic hexagonal ferrite powder obtained by the dry comminution step has a passage rate through a 150 micrometer mesh of equal to or higher than 90% and a stearic acid adsorption capacity of equal to or greater than 7.0 μmol/m².

6. The method of manufacturing a magnetic recording medium according to claim 1, wherein the ferromagnetic hexagonal ferrite powder obtained by the dry comminution step has a specific surface area by BET method, S_{BET}, of equal to or greater than 80 m²/g.

7. The method of manufacturing a magnetic recording medium according to claim 1, wherein an amount of binder adsorbed to the ferromagnetic hexagonal ferrite powder in the dispersion liquid obtained by the first dispersion step ranges from 9.8 to 12.0 weight parts per 100 weight parts of the ferromagnetic hexagonal ferrite powder.

8. The method of manufacturing a magnetic recording medium according to claim 1, wherein the magnetic layer formed has a squareness ranging from 0.5 to 0.9 in a longitudinal direction.

9. The method of manufacturing a magnetic recording medium according to claim 1, wherein the magnetic layer formed has a thickness ranging from 10 to 100 nm.

10. The method of manufacturing a magnetic recording medium according to claim 1, wherein a ratio, Sdc/Sac, of an average area Sdc of magnetic clusters in a DC demagnetized state to an average area Sac of magnetic clusters in an AC demagnetized state as measured by a magnetic force microscope, MFM, ranges from 0.8 to 2.0 in the magnetic recording medium obtained.

11. The method of manufacturing a magnetic recording medium according to claim 1, wherein the first dispersion step is carried out with an open kneader, ultrasonic disperser, or a disper.

12. The method of manufacturing a magnetic recording medium according to claim 1, wherein the second dispersion step is carried out by stirring the dispersion liquid obtained by the first dispersion step with a dispersion medium in the form of beads.

13. The method of manufacturing a magnetic recording medium according to claim 1, comprising coating a nonmagnetic layer coating liquid comprising a nonmagnetic powder and a binder on the nonmagnetic support and drying the nonmagnetic layer coating liquid to form a nonmagnetic layer, and coating the magnetic layer coating liquid on the nonmagnetic layer.

14. A magnetic recording medium, manufactured by the method according to claim 1.
